(19) United States
(12) Patent Application Publication
(10) Pub. No.: US 2019/0023943 A1
(43) Pub. Date: Jan. 24, 2019

(54) METHOD FOR PRODUCING COMPOSITE RESIN

(71) Applicant: KANEKA CORPORATION, Osaka (JP)

(72) Inventors: Hiroki Fukaumi, Hyogo (JP); Youichi Matsuo, Hyogo (JP)

(73) Assignee: KANEKA CORPORATION, Osaka (JP)

(21) Appl. No.: 16/144,591

(22) Filed: Sep. 27, 2018

Related U.S. Application Data
(63) Continuation of application No. PCT/JP2017/007762, filed on Feb. 28, 2017.

(30) Foreign Application Priority Data
Apr. 1, 2016 (JP) 2016-074480

(51) Int. Cl. C09D 183/10; C08G 77/442

(52) U.S. Cl. CPC C09D 183/10; C08G 2150/00; C08G 77/442

(57) ABSTRACT

A method for producing a composite resin includes preparing an organopolysiloxane by performing a hydrolyzing and condensing process on an organotrialkoxysilane comprising alkoxysilyl groups and a hydrocarbon group, and obtaining the composite resin by reacting the organopolysiloxane with an acrylic silicon in a reaction solution. The reaction solution includes the organopolysiloxane, the acrylic silicon, a water-soluble organic solvent, and an acid catalyst. The reaction solution has a solid content ranging from 30 to 55% by weight, and the water-soluble organic solvent has 4 or more carbon atoms. The composite resin contains the organopolysiloxane in an amount of 40 to 90% by weight and the acrylic silicon in an amount of 10 to 60% by weight, and the acrylic silicon has a number average molecular weight of 1000 to 9000.

### TECHNICAL FIELD

One or more embodiments of the present invention relate to a method for producing a composite resin. More specifically, one or more embodiments of the present invention relate to a method for producing a composite resin obtained by subjecting organopolysiloxane and acrylic silicon to a compositing reaction.

### BACKGROUND

Polysiloxane paint has been studied for a long time so that a coated film can have a longer life, particularly so that a coated film can have high weatherability and high heat resistance (Patent Literatures 1 to 3). This is because, since a siloxane bond forming polysiloxane is strong in terms of energy, the polysiloxane is not easily decomposed by heat and/or ultraviolet rays.

### CITATION LIST

[Patent Literature 1]

Japanese Patent Application Publication, Tokukaihei, No. 9-176489 (Publication Date: Jul. 8, 1997)

[Patent Literature 2]

Japanese Patent Application Publication, Tokukaihei, No. 11-343419 (Publication Date: Dec. 14, 1999)

[Patent Literature 3]

Japanese Patent Application Publication, Tokukai, No. 2013-87258 (Publication Date: May 13, 2013)

It is difficult to cause polysiloxane to linearly have a higher molecular weight. In view of this, in order to achieve durability which a coated film is required to have at least, it is necessary to use a multifunctional monomer to cause polysiloxane to three-dimensionally have a higher molecular weight. To this end, a resultant coated film is made fragile and may crack due to, for example, a temperature cycle test. Furthermore, since the resultant coated film is subjected to condensation while being formed, not only the coated film is under great contraction stress, but also a polymer which has three-dimensionally grown is poor in compatibility. This causes the coated film to be less adhesive to various base materials. Moreover, in a case where three-dimensional growth of the polymer progresses over time, unfortunately, the coated film may gelate. Under the circumstances, polysiloxane paint has been less widely used. In view of the above, a compositing reaction has been studied in which acrylic silicon is reacted and composited with polysiloxane. However, no sufficient study has been carried out with respect to an influence of the composition and the molecular weight of acrylic silicon on (i) storage stability of a composite resin and (ii) various physical properties of a resultant coated film. For example, according to Examples of Patent Literature 1, acrylic silicon has a number average molecular weight of approximately 10000, which is a high molecular weight. This may cause gelation of a coated film over time in a case where the acrylic silicon is subjected to a compositing reaction in which polysiloxane is reacted and composited with the acrylic silicon at a high concentration. This makes it necessary to take measures such as (i) a reduction in amount of water and/or a catalyst to be used for a reaction and (ii) a reduction in solid content concentration during the reaction. Note, however, that such measures may prevent satisfactory progress of the compositing reaction and consequently make it impossible to obtain a highly alkali-resistant coated film.

### SUMMARY

One or more embodiments of the present invention provide a method for producing a composite resin which simultaneously has high heat resistance, temperature cycle resistance, adhesion to a base material, and alkali resistance, which contains an organopolysiloxane segment, and which has favorable storage stability.

The inventors carried out a study and found one or more embodiments of the present invention. Embodiments of the present invention may include the following features:

[1] A method for producing a composite resin (A) which is obtained by reacting organopolysiloxane (a1) and acrylic silicon (a2), the organopolysiloxane (a1) being obtained by carrying out a process for hydrolyzing and condensing organotrialkoxysilane whose organic group is a hydrocarbon group, the method includes the step of: using a water-soluble organic solvent having 4 or more carbon atoms, and reacting the organopolysiloxane (a1) and the acrylic silicon (a2) at a solid content concentration of 30% by weight to 55% by weight in the presence of an acid catalyst, the composite resin (A) containing the organopolysiloxane (a1) in an amount of 40% by weight to 90% by weight and the acrylic silicon (a2) in an amount of 10% by weight to 60/o by weight, and the acrylic silicon (a2) having a number average molecular weight of 1000 to 9000.

[2] The method recited in [1], wherein a monomer unit containing a hydrolyzable silyl group accounts for 3% by weight to 11% by weight of monomer units constituting the acrylic silicon (a2).

[3] The method recited in [1] or [2], wherein the organotrialkoxysilane whose organic group is a hydrocarbon group is methyltrimethoxysilane.

[4] The method recited in any one of [1] through [3], wherein a vinyl monomer constituting the acrylic silicon (a2) contains one or more kinds of silane monomers selected from the group consisting of 3-(meth)acryloyloxy propyltrimethoxysilane, 3-methacryloyloxy propylmethyl dimethoxysilane, and 3-methacryloyloxy propyltriethoxysilane.

[5] The method recited in any one of [1] through [4], wherein a vinyl monomer constituting the acrylic silicon (a2) contains methacrylate ester in an amount of not less than 65% by weight.

[6] The method recited in any one of [1] through [5], wherein a vinyl monomer constituting the acrylic silicon (a2) contains methyl methacrylate in an amount of not less than 50% by weight.

[7] The method recited in any one of [1] through [6], wherein water is added in an amount of 0.6 moles to 4.0 moles with respect to 1 mole of an alkoxysilyl group during the process for hydrolyzing and condensing the organotrialkoxysilane whose organic group is a hydrocarbon group.

[8] A method for producing a cured product, includes the step of: curing a composite resin (A) produced by a method recited in any one of [1] through [7].

[9] A method for producing a laminate, includes the steps of: applying, to a base material, a composite resin (A) produced by a method recited in any one of [1] through [7]; and forming a cured film.

[10] A method for producing a laminate, includes the steps of: applying, to a base material to which a coating solution containing acrylic silicon (a2) has been applied, a composite resin (A) produced by a method recited in any one of [1] through [7]; and forming a cured film.

[11] The method recited in [10], wherein the coating solution containing the acrylic silicon (a2) contains alkylsilicate.

One or more embodiments of the present invention make it possible to provide a method for producing a composite resin which simultaneously has high heat resistance, temperature cycle resistance, adhesion to a base material, and alkali resistance, which contains an organopolysiloxane segment, and which has favorable storage stability.

### DESCRIPTION OF EMBODIMENTS

One or more embodiments of the present invention relate to a method for producing a composite resin (A) which is obtained by reacting organopolysiloxane (a1) and acrylic silicon (a2), the organopolysiloxane (a1) being obtained by carrying out a process for hydrolyzing and condensing organotrialkoxysilane whose organic group is a hydrocarbon group, the method including the step of: using a water-soluble organic solvent having 4 or more carbon atoms, and reacting the organopolysiloxane (a1) and the acrylic silicon (a2) at a solid content concentration of 30% by weight to 55% by weight in the presence of an acid catalyst, the composite resin (A) containing the organopolysiloxane (a1) in an amount of 40% by weight to 90% by weight and the acrylic silicon (a2) in an amount of 10% by weight to 60% by weight, and the acrylic silicon (a2) having a number average molecular weight of 1000 to 9000.

Note that numerical expressions such as “A to B” herein mean “not less than A and not more than B” unless otherwise specified.

<Organopolysiloxane (a1)>

In one or more embodiments, specific examples of organotrialkoxysilane which constitutes organopolysiloxane and whose organic group is a hydrocarbon group include methyltrimethoxysilane, methyltriethoxysilane, methyltriisopropoxysilane, ethyltrimethoxysilane, ethyltriethoxysilane, ethyltriisopropoxysilane, propyltrimethoxysilane, propyltriethoxysilane, propyltriisopropoxysilane, butyltrimethoxysilane, butyltriethoxysilane, butyltriisopropoxysilane, hexyltrimethoxysilane, hexyltriethoxysilane, hexyltriisopropoxysilane, octyltrimethoxysilane, octyltriethoxysilane, and octyltriisopropoxysilane.

In one or more embodiments where an alkoxy group has preferably 1 carbon atom or 2 carbon atoms, and most preferably 1 carbon atom, an alkoxysilyl group is easily hydrolyzed and condensed. Furthermore, the number of carbon atoms possessed by an organic group of the organotrialkoxysilane is important from the viewpoint of reactivity, during curing, of (i) an alkoxysilyl group or a silanol group obtained through hydrolysis of the alkoxysilyl group and (ii) organopolysiloxane. The organic group of the organotrialkoxysilane has preferably 1 carbon atom or 2 carbon atoms, and most preferably 1 carbon atom because steric repulsion caused by organic groups is preferably less likely to occur. Furthermore, in view of availability and cost, the organotrialkoxysilane is most preferably methyltrimethoxysilane.

In one or more embodiments, the organotrialkoxysilane is hydrolyzed and condensed by adding water in an amount of preferably 0.6 moles to 4.0 moles with respect to 1 mole of the alkoxysilyl group. In a case where water is added in an amount of less than 0.6 moles, reaction of the organotrialkoxysilane is not completed, and part of the organotrialkoxysilane remains without being made higher in molecular weight. Thus, the organotrialkoxysilane volatilizes in a reduced-pressure distillation step, which is a step of removing alcohol generated during the reaction. As a result, the organotrialkoxysilane is lost. Furthermore, a silanol group which is generated through hydrolysis of an alkoxysilyl group triggers a reduction in storage stability of the organopolysiloxane because the silanol group causes dehydration condensation between the silanol group and another silanol group and/or dealcoholization condensation between the silanol group and another alkoxysilyl group. Meanwhile, the silanol group solvates with a hydrophilic solvent such as alcohol. Thus, the silanol group whose amount is not less than a certain amount also brings about an effect of enhancing storage stability of the organopolysiloxane. Moreover, the organopolysiloxane which is concentrated in the reduced-pressure distillation step easily gelates. This may make it impossible for the organopolysiloxane to be concentrated to such an extent as to have a high concentration. From this viewpoint, water is more preferably added in an amount of not less than 0.8 moles.

In one or more embodiments there is no particular upper limit of an amount of water to be added. Note, however, that water is preferably added in an amount of not more than 4.0 moles because a reduction in solid content concentration during production of the organopolysiloxane increases production cost. From the above viewpoints, water is added in an amount of still more preferably 0.8 moles to 2.0 moles, and particularly preferably 0.8 moles to 1.5 moles, with respect to 1 mole of the alkoxysilyl group.

In one or more embodiments where the organotrialkoxysilane is hydrolyzed and condensed, a catalyst is preferably added so that a reaction speed is increased. A catalyst for hydrolysis and condensation of the alkoxysilyl group is roughly classified into a base catalyst and an acid catalyst, and the acid catalyst is more preferable. In hydrolysis and condensation of the alkoxysilyl group, the base catalyst frequently exhibits an effect of causing condensation in particular to be accelerated. Thus, the organopolysiloxane which is obtained with use of the base catalyst contains the silanol group in a small amount. This causes the organopolysiloxane to be more likely to have low storage stability for the reasons described earlier. Meanwhile, the acid catalyst frequently exhibits an effect of causing hydrolysis in particular to be further accelerated than condensation. Thus, the organopolysiloxane which is obtained with use of the acid catalyst contains the silanol group in a large amount, and such an organopolysiloxane exhibits favorable storage stability in a solvent in which the organopolysiloxane can solvate with the silanol group of the organopolysiloxane.

The acid catalyst of one or more embodiments is preferably an organic acid in terms of compatibility of the organic acid with the organopolysiloxane and a diluting solvent, and phosphoric ester or carboxylic acid can be suitably used. Specific examples of the organic acid include ethyl acid phosphate, butyl acid phosphate, dibutyl pyrophosphate, butoxyethyl acid phosphate, 2-ethylhexyl acid phosphate, isotridecyl acid phosphate, dibutyl phosphate, bis(2-ethylhexyl)phosphate, formic acid, acetic acid, butyric acid, and isobutyric acid. The catalyst is added in an amount of preferably 50 ppm to 3% by weight, more preferably 100 ppm to 1% by weight, particularly preferably 100 ppm to 0.5% by weight, and most preferably 100 ppm to 1000 ppm, with respect to the organotrialkoxysilane. The catalyst which is added in an amount of less than 50 ppm hardly functions as a catalyst. The catalyst which is added in a large amount can make a reaction time shorter but is frequently less easy to separate and remove from organopolysiloxane after the reaction is finished. The catalyst which remains may cause the organopolysiloxane (a1) and the composite resin (A) to have lower water resistance. Thus, the catalyst which is added in a smaller amount is suitable in a practical view, though depending on a balance with time of production of the organopolysiloxane.

Furthermore, a diluting solvent can be used during production of the organopolysiloxane of one or more embodiments. Since the organotrialkoxysilane is hydrophobic and water is used during the reaction, the diluting solvent is preferably soluble in water. There is no limit to an amount in which the diluting solvent is used. Note, however, that the diluting solvent which is used in a larger amount causes a reduction in concentration of the resultant organopolysiloxane (a1) and thus is not preferable in terms of production cost. In a case where the organic group of the organotrialkoxysilane has 3 or more carbon atoms, the resultant organopolysiloxane (a1) is frequently incompatible with alcohol (methanol, ethanol, or propanol) which is generated during production. Thus, the organotrialkoxysilane is preferably subjected to the reaction in a compatibilizing system with use of the diluting solvent. From this viewpoint, the diluting solvent is suitably a hydrophilic solvent which has 4 or more carbon atoms. The hydrophilic solvent which has 3 or less carbon atoms may have insufficient solubility in the organopolysiloxane (a1) as described earlier. Specific examples of the diluting solvent include diethylene glycol monomethyl ether, triethylene glycol monomethyl ether, polyethylene glycol monomethyl ether, ethylene glycol monoethyl ether, ethylene glycol monoisopropyl ether, diethylene glycol monoisopropyl ether, ethylene glycol monobutyl ether, diethylene glycol monobutyl ether, triethylene glycol monobuthyl ether, ethylene glycol monoisobutyl ether, diethylene glycol monoisobutyl ether, propylene glycol monomethyl ether, propylene glycol dimethyl ether, dipropylene glycol monomethyl ether, tripropylene glycol monomethyl ether, propylene glycol monoethyl ether, propylene glycol monopropyl ether, ethylene glycol dimethyl ether, diethylene glycol dimethyl ether, triethylene glycol dimethyl ether, diethylene glycol methylethyl ether, diethylene glycol diethyl ether, and ethylene glycol diethyl ether. Of these diluting solvents, a diluting solvent which has a boiling point of not higher than 150° C. under atmospheric pressure is preferable in view of necessity to cause the diluting solvent to volatilize after production of the composite resin (A) and during formation of a coated film. The diluting solvent is particularly preferably ethylene glycol monoethyl ether, ethylene glycol monoisopropyl ether, propylene glycol monomethyl ether, propylene glycol monopropyl ether, propylene glycol monoethyl ether, or propylene glycol dimethyl ether.

<Acrylic Silicon (a2)>

In one or more embodiments of the present invention, the acrylic silicon (a2) refers to a (meth)acrylic resin having an alkoxysilyl group on a side chain thereof. A method of introducing the alkoxysilyl group into the (meth)acrylic resin is preferably a method of using (meth)acryloyloxy alkyl alkoxysilane, and particularly preferably a method of using one or more kinds of silane monomers selected from the group consisting of 3-(meth)acryloyloxy propyltrimethoxysilane, 3-(meth)acryloyloxy propylmethyl dimethoxysilane, and 3-(meth)acryloyloxy propyltriethoxysilane. Commercial products of 3-(meth)acryloyloxy propyltrimethoxysilane, 3-methacryloyloxy propylmethyl dimethoxysilane, and 3-methacryloyloxy propyltriethoxysilane are available and can be suitably used due to their availability.

Examples of a method of introducing the alkoxysilyl group into the side chain include a method of adding aminoalkyl alkoxysilane or mercaptoalkyl alkoxysilane to glycidyl (meth)acrylate; and a method of adding 3-glycidoxypropyl trialkoxysilane to (meth)acrylate. Note, however, that such a method is not preferable in one or more embodiments of the present invention because an amino group per se is basic and a catalyst which is used in a method of adding a mercapto group or a carboxyl group to an epoxy group is basic.

The acrylic silicon (a2) of one or more embodiments is obtained by copolymerizing (i) a (meth)acrylic monomer which contains the alkoxysilyl group and (ii) a widely-used (meth)acrylic monomer. The widely-used (meth)acrylic monomer is not particularly limited. Instead of the widely-used (meth)acrylic monomer, a vinyl monomer can be alternatively copolymerized. Examples of the widely-used (meth)acrylic monomer and the vinyl monomer include alkyl(meth)acrylates containing alkyl groups having 1 to 22 carbon atoms, such as methyl(meth)acrylate, ethyl(meth)acrylate, n-propyl(meth)acrylate, n-butyl(meth)acrylate, isobutyl(meth)acrylate, tert-butyl(meth)acrylate, 2-ethylhexyl(meth)acrylate, and lauryl(meth)acrylate; aralkyl(meth)acrylates such as benzyl(meth)acrylate and 2-phenyl ethyl(meth)acrylate; cycloalkyl(meth)acrylates such as cyclohexyl(meth)acrylate and isobornyl(meth)acrylate; ω-alkoxyalkyl(meth)acrylates such as 2-methoxyethyl(meth)acrylate and 4-methoxybutyl(meth)acrylate; carboxylic acid vinyl esters such as vinyl acetate, vinyl propionate, vinyl pivalate, and vinyl benzoate; crotonic acid alkyl esters such as methyl crotonate and ethyl crotonate; unsaturated diacid dialkyl esters such as dimethyl malate, di-n-butyl malate, dimethyl fumarate, and dimethyl itaconate; α-olefins such as ethylene and propylene; fluoroolefins such as vinylidene fluoride, tetrafluoroethylene, hexafluoropropylene, and chlorotrifluoroethylene; alkyl vinyl ethers such as ethyl vinyl ether and n-butyl vinyl ether; cycloalkyl vinyl ethers such as cyclopentyl vinyl ether and cyclohexyl vinyl ether; and tertiary amide group-containing monomers such as N,N-dimethyl(meth)acrylic amide, N-(meth)acryloyl morpholine, N-(meth)acryloyl pyrrolidine, and N-vinyl pyrrolidone.

In order that the resultant composite resin (A) of one or more embodiments has higher heat resistance and better adhesion to a base material, the vinyl monomer constituting the acrylic silicon (a2) preferably contains methacrylate ester in an amount of not less than 65% by weight, more preferably contains methacrylate ester in an amount of not less than 70% by weight, particularly preferably contains methacrylate ester in an amount of not less than 80% by weight, and most preferably contains methacrylate ester in an amount of not less than 90% by weight. In a case where the vinyl monomer contains methacrylate ester in an amount of less than 65% by weight, the methacrylate ester which is contained in a smaller amount tends to cause the resultant composite resin (A) to have lower heat resistance and poorer adhesion to the base material.

Furthermore, in one or more embodiments the vinyl monomer constituting the acrylic silicon (a2) preferably contains methyl methacrylate in an amount of not less than 50% by weight. During production of the composite resin (A), compatibility between the organopolysiloxane (a1) and the acrylic silicon (a2) is important. Thus, the vinyl monomer constituting the acrylic silicon (a2) is suitably highly hydrophilic. Meanwhile, the vinyl monomer which contains a carboxyl group or a hydroxy group and is contained in the acrylic silicon (a2) in a large amount may cause the composite resin (A) to have lower water resistance. Thus, the vinyl monomer is most preferably methyl methacrylate. The methyl methacrylate is contained in the acrylic silicon (a2) in an amount of more preferably not less than 60% by weight, and particularly preferably not less than 70% by weight.

In one or more embodiments a monomer unit (silane monomer) containing a hydrolyzable silyl group accounts for preferably 3% by weight to 11% by weight, more preferably 3% by weight to 8% by weight, and particularly preferably 4% by weight to 8% by weight, of monomer units constituting the acrylic silicon (a2). The silane monomer which is contained in the acrylic silicon (a2) in an amount of more than 11% by weight tends to cause the composite resin (A) which has been synthesized to thicken and gelate over time. Meanwhile, the silane monomer which is contained in the acrylic silicon (a2) in an amount of less than 3% by weight prevents a compositing reaction between the organopolysiloxane (a1) and the acrylic silicon (a2) from being sufficiently carried out, and consequently tends to cause white turbidity of the resultant composite resin (A). Not only the amount of the silane monomer contained in the acrylic silicon (a2) but also hydrophilicity of the widely-used (meth)acrylic monomer mentioned earlier is an important factor for obtainment of the composite resin (A) which is transparent. In a case where the widely-used (meth)acrylic monomer has higher hydrophilicity, the organopolysiloxane (a1) and the acrylic silicon (a2) tend to be more compatible and more reactive with each other. This makes it easier to obtain the composite resin (A) which is transparent.

A polymerization method, a solvent, or a polymerization initiator which is used to copolymerize the monomers is not particularly limited. The acrylic silicon (a2) can be obtained by use of a publicly known polymerization method, a publicly known solvent, or a publicly known polymerization initiator. The acrylic silicon (a2) can be obtained by, for example, employing any of various polymerization methods such as a massive radical polymerization method, a solution radical polymerization method, and a non-aqueous dispersion radical polymerization method, and using any of widely-used polymerization initiators such as 2,2′-azobis(isobutyronitrile), 2,2′-azobis(2,4-dimethylvaleronitrile), 2,2′-azobis(2-methylbutyronitrile), tert-butyl peroxypivalate, tert-butyl peroxybenzoate, tert-butyl peroxy-2-ethylhexanoate, di-tert-butyl peroxide, cumene hydroperoxide, and diisopropyl peroxycarbonate. The acrylic silicon (a2) has an average molecular weight which falls within the range of 1000 to 9000 in terms of a number average molecular weight (Mn). In a case where the acrylic silicon (a2) has a number average molecular weight which falls within the above range, it is possible to prevent white turbidity and precipitation, and gelation during production of the composite resin (A), and to allow the composite resin (A) to be highly durable. The acrylic silicon (a2) has a number average molecular weight which falls within the range of more preferably 1000 to 8000, and still more preferably 1000 to 7000. This is because such acrylic silicon (a2) allows the composite resin (A) to be produced at a high concentration without gelating. The acrylic silicon (a2) which has a number average molecular weight of less than 1000 is not preferable. This is because such acrylic silicon (a2) (i) cannot be substantially synthesized by a radical polymerization method in which such a widely-used polymerization initiator as mentioned earlier is used, (ii) necessitates a complicated process such as a control living radical polymerization method, and (iii) causes a substantial increase in production cost. The acrylic silicon (a2) which has a number average molecular weight of more than 9000 raises a fear that the composite resin (A) which is obtained through the compositing reaction between the organopolysiloxane (a1) and the acrylic silicon (a2) may be made so high in molecular weight as to gelate. The acrylic silicon (a2) which has a higher molecular weight is less compatible with the organopolysiloxane (a1). Thus, in order to subject the organopolysiloxane (a1) and the acrylic silicon (a2) to the compositing reaction, it is necessary to take a measure such as copolymerization of a large amount of monomers having a hydrolyzable silyl group, and/or an increase in amount of the catalyst. Meanwhile, the above measure causes the composite resin (A) to have a higher molecular weight, so that the composite resin (A) is highly likely to gelate.

In one or more embodiments where the composite resin (A) is produced at a higher solid content concentration, the compositing reaction between the organopolysiloxane (a1) and the acrylic silicon (a2) is promoted. This causes the composite resin (A) to have a higher molecular weight. Thus, both the number average molecular weight of the acrylic silicon (a2) and the solid content concentration during the compositing reaction are determinants of a structure of the composite resin (A). The composite resin (A) which has a too high molecular weight gelates. This makes it necessary to appropriately adjust the above number average molecular weight and the above solid content concentration in accordance with a purpose. The alkoxysilyl group which is contained in the acrylic silicon (a2) is hydrolyzed to the silanol group during production of the composite resin (A) and then subjected to a condensation process so as to be formed into a siloxane bond. Thus, the alkoxysilyl group and the silanol group are virtually nonexistent in an acrylic silicon segment of the composite resin (A), which is an end product. Note, however, that even the alkoxysilyl group and the silanol group which remain in the acrylic silicon segment cause no problem. Since hydrolysis of the alkoxysilyl group and condensation of the silanol group progress while the composite resin (A) is being cured, a resultant cured product has a higher crosslinking density, so that a cured product which is excellent in heat resistance and chemical resistance can be formed.

<Composite Resin (A)>

The composite resin (A) of one or more embodiments is a resin obtained by reacting the organopolysiloxane (a1) and the acrylic silicon (a2) so as to obtain a composite of the organopolysiloxane (a1) and the acrylic silicon (a2). The composite of the organopolysiloxane (a1) and the acrylic silicon (a2) is obtained by reacting the alkoxysilyl group, which is a reactive functional group of the organopolysiloxane (a1), and the silanol group, which is a reactive functional group of the acrylic silicon (a2). The organopolysiloxane (a1) is preferably synthesized in the absence of the acrylic silicon (a2). There have been conventionally proposed many techniques such that the acrylic silicon (a2) is synthesized and then an organoalkoxysilane compound, water, and a catalyst for hydrolysis of the alkoxysilyl group and condensation of the silanol group are added to a solution of the acrylic silicon (a2) so that synthesis of the organopolysiloxane (a1) and the compositing reaction between the organopolysiloxane (a1) and the acrylic silicon (a2) simultaneously progress. However, such a technique causes the alkoxysilyl group and the silanol group which are unreacted to easily remain. This raises a fear of a deterioration in performance of a coated film of the composite resin (A). Furthermore, though the above reaction can also be satisfactorily progressed by increasing a reaction temperature and/or using a catalyst, the organoalkoxysilane serves as a cross-linking agent with respect to the acrylic silicon (a2) and easily gelates. In contrast, in a case where the organopolysiloxane (a1) is synthesized in advance, it is possible to achieve a lower amount of the alkoxysilyl group and the silanol group which are unreacted. The organopolysiloxane (a1) and the acrylic silicon (a2) which are being subjected to the compositing reaction also have a high molecular weight. This makes it possible to restrain gelation of the entire reaction system by steric hindrance, so that only the compositing reaction can be caused in a minimum amount required for obtainment of a uniform coated film.

During the compositing reaction of one or more embodiments, a compositing ratio of the organopolysiloxane (a1) is 40% by weight to 90% by weight, and a compositing ratio of the acrylic silicon (a2) is 10% by weight to 60% by weight (note that a total of the (a1) and the (a2) is 100% by weight). A lower compositing ratio of the organopolysiloxane (a1) tends to cause the composite resin (A) to have lower heat resistance, whereas a too high compositing ratio of the organopolysiloxane (a1) tends to cause the composite resin (A) to be less flexible and less adhesive to the base material. From this viewpoint, the compositing ratio of the organopolysiloxane (a1) is preferably 50% by weight to 90% by weight, particularly preferably 50% by weight to 80% by weight, and most preferably 50% by weight to 70% by weight. The compositing ratio of the organopolysiloxane (a1) can be calculated based on the following expression: “blended amount of organopolysiloxane (a1)/(blended amount of organopolysiloxane (a1)+blended amount of acrylic silicon (a2))×100” For example, in a case where the compositing reaction in which 70 g of the acrylic silicon (a2) is reacted and composited with 30 g of the organopolysiloxane (a1) is carried out, the compositing ratio of the organopolysiloxane (a1) is calculated as follows: “30/(30+70)×100=30% by weight”

In one or more embodiments where the compositing reaction is carried out, an acid catalyst can be suitably used. As the acid catalyst, it is possible to suitably use phosphoric ester, carboxylic acid, or the like serving as the acid catalyst which is used to produce the organopolysiloxane (a1). A total of (i) an amount of the catalyst which is added during the compositing reaction and (ii) an amount of the catalyst which is used to produce the organopolysiloxane (a1) is preferably 0.1% by weight to 5.0% by weight, more preferably 0.1% by weight to 2.0% by weight, particularly preferably 0.1% by weight to 1.5% by weight, and most preferably 0.1% by weight to 1.0% by weight, with respect to the composite resin (A). Since the catalyst is used to produce the organopolysiloxane (a1), it is possible to produce the composite resin (A) without adding the catalyst during the compositing reaction between the organopolysiloxane (a1) and the acrylic silicon (a2). However, in a case where the total of the amounts of the catalysts is less than 0.1% by weight, the compositing reaction may unsatisfactorily progress. The catalyst(s) which is/are used in a large amount(s) can make the reaction time shorter. However, after a step of heating and reacting the organopolysiloxane (a1) and the acrylic silicon (a2) is finished, the composite resin (A) may gelate due to further progress of the reaction over time even at a room temperature. The amount(s) of the catalyst(s) added need(s) to be appropriately adjusted in accordance with a molecular weight and/or the composition of the acrylic silicon (a2). Note, however, that the amount(s) of the catalyst(s) added is/are preferably small enough to cause progress of the compositing reaction in the step of heating and reacting the organopolysiloxane (a1) and the acrylic silicon (a2), but prevent progress of the compositing reaction at the room temperature.

During the compositing reaction of one or more embodiments, a reaction solution is preferably heated to 50° C. to 150° C. As described earlier, the amount(s) of the catalyst(s) added is/are appropriately adjusted in accordance with the reaction temperature. Thus, in a case where the organopolysiloxane (a1) and the acrylic silicon (a2) are reacted with each other at a temperature of lower than 50° C., it may be impossible to restrain the reaction even by cooling the reaction solution to the room temperature. Meanwhile, even in a case where the reaction solution is heated so as to have a temperature of higher than 150° C., the reaction solution frequently has a temperature of not higher than 150° C. due to reflux of alcohol and/or water which is/are generated during the compositing reaction between the organopolysiloxane (a1) and the acrylic silicon (a2). Thus, the reaction solution which is heated so as to have a temperature of higher than 150° C. is not preferable from the viewpoint of energy loss. Furthermore, in a case where (i) the organopolysiloxane (a1) and the acrylic silicon (a2) are reacted with each other at a temperature at which the reaction solution furiously boils and (ii) an air bubble is broken, a resin which is present at or near the air bubble may be locally concentrated and gelate, and precipitate. Thus, the reaction temperature is preferably approximately a boiling point of the reaction solution (a temperature which is slightly lower than the boiling point).

During the compositing reaction of one or more embodiments, alcohol generated during production of the organopolysiloxane (a1) is preferably removed in advance. This is because, since the organopolysiloxane (a1) is produced from the organotrialkoxysilane, any of methanol, ethanol, propanol, and 2-propanol is frequently generated from the organotrialkoxysilane during production of the organopolysiloxane (a1). An alcohol having 3 or less carbon atoms is commonly less soluble in the acrylic silicon (a2). In a case where the organopolysiloxane (a1) and the acrylic silicon (a2) are mixed, or during the compositing reaction between the organopolysiloxane (a1) and the acrylic silicon (a2), the alcohol having 3 or less carbon atoms easily causes precipitation of the acrylic silicon (a2) and/or gelation of the composite resin (A). The organopolysiloxane (a1) and the acrylic silicon (a2) which are used in the compositing reaction are respective polymer solutions each of which contains a diluting solvent. A mixed solution of these polymer solutions is not particularly limited provided that the mixed solution has the composition which allows the organopolysiloxane (a1) and the acrylic silicon (a2), and the composite resin (A) to be dissolved in the mixed solution. However, in a case where the organopolysiloxane (a1) contains, in a large amount, alcohol having 3 or less carbon atoms, the alcohol is brought into contact with the acrylic silicon (a2), and it is feared that precipitation occurs in the polymer solutions which have not been completely mixed, and that gelation occurs in part of the polymer solutions. Thus, during the compositing reaction, preferably not less than 70% by weight, still more preferably not less than 80% by weight, particularly preferably not less than 90% by weight, and most preferably substantially all of the alcohol which is generated during production of the organopolysiloxane (a1) is removed in advance. A substantial upper limit of an amount of the alcohol removed is, for example, 98% by weight, depending on a reaction condition.

During the compositing reaction of one or more embodiments, the reaction solution has a solid content concentration of 30% by weight to 55° % by weight after the organopolysiloxane (a1) and the acrylic silicon (a2) are mixed. A lower solid content concentration tends to cause the organopolysiloxane (a1) and the acrylic silicon (a2) to be less reactive with each other. This is because, since each of the organopolysiloxane (a1) and the acrylic silicon (a2) is a resin, the alkoxysilyl group, which is a reactive functional group of the organopolysiloxane (a1), and the silanol group, which is a reactive functional group of the acrylic silicon (a2), are sterically prevented from getting close to each other. The organopolysiloxane (a1) and the acrylic silicon (a2) can be made more reactive with each other by increasing the solid content concentration so as to spatially restrict diffusion of the resins in the solution. Meanwhile, in a case where the solid content concentration is excessively increased, the organopolysiloxane (a1) and the acrylic silicon (a2) are made too reactive with each other. This may cause the composite resin (A) to have a molecular weight so high as to exceed solubility of the diluting solvent, and consequently cause the composite resin (A) to be insolubilized and gelate. In view of the above, the solid content concentration is more preferably 40% by weight to 55% by weight, and particularly preferably 45% by weight to 55% by weight.

The diluting solvent, which is used during the compositing reaction of one or more embodiments, is suitably a hydrophilic solvent having 4 or more carbon atoms. Specific examples of the hydrophilic solvent include diethylene glycol monomethyl ether, triethylene glycol monomethyl ether, polyethylene glycol monomethyl ether, ethylene glycol monoethyl ether, ethylene glycol monoisopropyl ether, diethylene glycol monoisopropyl ether, ethylene glycol monobutyl ether, diethylene glycol monobutyl ether, triethylene glycol monobuthyl ether, ethylene glycol monoisobutyl ether, diethylene glycol monoisobutyl ether, propylene glycol monomethyl ether, propylene glycol dimethyl ether, dipropylene glycol monomethyl ether, tripropylene glycol monomethyl ether, propylene glycol monoethyl ether, propylene glycol monopropyl ether, ethylene glycol dimethyl ether, diethylene glycol dimethyl ether, triethylene glycol dimethyl ether, diethylene glycol methylethyl ether, diethylene glycol diethyl ether, and ethylene glycol diethyl ether. Of these hydrophilic solvents, a hydrophilic solvent which has a boiling point of not higher than 150° C. under atmospheric pressure is preferable in view of necessity to cause the hydrophilic solvent to volatilize after use of the hydrophilic solvent. The hydrophilic solvent is particularly preferably ethylene glycol monoethyl ether, ethylene glycol monoisopropyl ether, propylene glycol monomethyl ether, propylene glycol monopropyl ether, propylene glycol monoethyl ether, or propylene glycol dimethyl ether.

In one or more embodiments a hydrophilic solvent having 3 or less carbon atoms is not suitable because such a hydrophilic solvent is insufficiently soluble in the acrylic silicon (a2) and the composite resin (A) as described earlier. Furthermore, a hydrophobic solvent is not suitable because the hydrophobic solvent is less soluble in (i) water which remains after being used to produce the organopolysiloxane (a1) and (ii) the silanol group which has been generated and remains. Note, however, that the hydrophilic solvent having 3 or less carbon atoms or the hydrophobic solvent can be used as part of the diluting solvent provided that the hydrophilic solvent having 3 or less carbon atoms or the hydrophobic solvent prevents precipitation of the composite resin (A).

<Curing Agent (B) for Curing Composite Resin (A)>

When a curing agent is added to the composite resin (A) in accordance with one or more embodiments of the present invention, curing of the composite resin (A) is promoted. This allows a reduction in operation time during formation of a coated film, which is a cured product. The curing agent is not limited to any particular curing agent, but all curing agents each generally known as a curing agent for an alkoxysilyl group are usable. Of the curing agents, a curing agent made of an organic tin compound, a curing agent made of a titanium chelate compound, a curing agent made of an aluminum chelate compound, or a curing agent made of an organic amine compound is preferable because such a curing agent allows the composite resin (A) to be highly curable and allows a resultant coated film to have excellent comprehensive physical properties.

Specific examples of the organic tin compound include dioctyl tin bis(2-ethylhexyl malate), a condensate of dioctyl tin oxide or dibutyl tin oxide and silicate, dibutyl tin dioctoate, dibutyl tin dilaurate, dibutyl tin distearate, dibutyl tin diacetylacetonato, dibutyl tin bis(etyl malate), dibutyl tin bis(butyl malate), dibutyl tin bis(2-ethylhexyl malate), dibutyl tin bis(oleyl malate), stannous octoate, stearic acid tin, and di-n-butyl tin laurate oxide. Specific examples of the organic tin compound which contains an S atom in its molecule include dibutyl tin bis isononyl-3-mercapto propionate, dioctyl tin bis isononyl-3-mercapto propionate, octyl butyl tin bis isononyl-3-mercapto propionate, dibutyl tin bis isooctyl thioglycolate, dioctyl tin bis isooctyl thioglycolate, and octyl butyl tin bis isooctyl thioglycolate.

Specific examples of the titanium chelate compound include titanium acetylacetonate, titanium tetraacetylacetonate, titanium ethyl acetoacetate, a titanium phosphate compound, titanium octylene glycolate, and titanium ethyl acetoacetate.

Specific examples of the aluminum chelate compound include ethyl acetoacetate aluminum diisopropylate, aluminum tris(acetyl acetate), aluminum tris(ethyl acetoacetate), aluminum monoacetylacetonate bis(ethyl acetoacetate), and alkyl acetyl acetate aluminum diisopropylate.

Specific examples of the organic amine compound include triethylamine, triethylene diamine, trimethylamine, tetramethylene diamine, N-methyl morpholine, N-ethyl morpholine, N,N′-diethyl-2-methyl piperazine, lauryl amine, and dimethyl lauryl amine.

These curing agents (B) of one or more embodiments can be used in two or more kinds as needed. An amount in which the curing agent (B) is used only needs to be appropriately adjusted in accordance with a curing temperature and a curing time. Note, however, that the curing agent (B) is used in an amount of preferably not less than 0.01 parts by weight and not more than 20 parts by weight, and particularly preferably not less than 0.1 parts by weight and not more than 5 parts by weight, with respect to 100 parts by weight of the composite resin (A). The curing agent (B) which is used in an amount of less than 0.01 parts by weight may prevent curing performance from being fully demonstrated, whereas the curing agent (B) which is used in an amount of more than 20 parts by weight tends to shorten a time for which the composite resin (A) is usable, and consequently to cause the composite resin (A) to be less workable.

<Laminate>

It is possible to produce a laminate by use of the composite resin (A) in accordance with one or more embodiments of the present invention and a base material.

A laminate in accordance with one or more embodiments of the present invention is obtained by a production method including the steps of: applying the composite resin (A) to the base material; and forming a cured film. The step of forming the cured film includes the step of drying a diluting solvent that is contained in a coated film obtained by applying the composite resin (A) to the base material. In the step of drying the diluting solvent, a heat source is used to promote the drying of the diluting solvent.

The base material which can be used in one or more embodiments of the present invention is exemplified by but not particularly limited to various base materials made of, for example, glass, polycarbonate (PC), acrylic, acrylic silicon, acrylonitrile butadiene styrene (ABS), ABS/PC, and polyethylene terephthalate (PET).

In one or more embodiments the composite resin (A) has good adhesion to an acrylic silicon coated film and a coated film containing acrylic silicon and alkylsilicate. Thus, the laminate in accordance with one or more embodiments of the present invention can also be obtained by a production method including the steps of: applying the composite resin (A) to a base material to which a coating solution containing the acrylic silicon (a2) is applied; and forming a cured film. The coating solution containing the acrylic silicon (a2) is preferably a coating solution containing alkylsilicate.

The coated film of one or more embodiments preferably has a thickness of 1 μm to 100 μm. The coated film which has a thickness of less than 1 μm tends to have insufficient humidity resistance and insufficient water resistance, and may damage the base material. The coated film which has a thickness of more than 100 μm may cause a crack in the coated film due to cure shrinkage that occurs during formation of the coated film.

The present invention is not limited to the aforementioned embodiments but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### EXAMPLES

The following description will discuss aspects of one or more embodiments of the present invention with reference to Examples and Comparative Examples. Note, however, that the present invention is not limited by the Examples.

The following are various substances used in Examples and Comparative Examples.
Organotrialkoxysilane

MTMS (A-1630; methyltrimethoxysilane, manufactured by Momentive Performance Materials Japan LLC and having a molecular weight of 136.2)

ETMS (ethyltrimethoxysilane, manufactured by Nacalai Tesque, Inc. and having a molecular weight of 150.3)

HTMS (KBM-3063; hexyltrimethoxysilane, manufactured by Shin-Etsu Chemical Co., Ltd. and having a molecular weight of 206.4)
Acrylic Silicon

MMA (methyl methacrylate, manufactured by Mitsubishi Gas Chemical Company, Inc. and having a molecular weight of 100.1)

BMA (butyl methacrylate, manufactured by Mitsubishi Gas Chemical Company, Inc. and having a molecular weight of 142.2)

BA (butyl acrylate, manufactured by Nippon Shokubai Co., Ltd. and having a molecular weight of 128.2)

AA (acrylic acid, manufactured by Nippon Shokubai Co., Ltd. and having a molecular weight of 72.1)

HEMA (methacrylic acid 2-hydroxyethyl, manufactured by Nippon Shokubai Co., Ltd. and having a molecular weight of 130.1)

A-174 (3-methacryloyloxy propyltrimethoxysilane, manufactured by Momentive Performance Materials Japan LLC and having a molecular weight of 248.4)

Z-6033 (3-methacryloyloxy propylmethyl dimethoxysilane, manufactured by Dow Corning Toray Co., Ltd. and having a molecular weight of 232.4)

Y-9936 (3-methacryloyloxy propyltriethoxysilane, manufactured by Momentive Performance Materials Japan LLC and having a molecular weight of 290.4)
Polymerization Initiator

V59 (2,2′-azobis(2-methylbutyronitrile), manufactured by Wako Pure Chemical Industries, Ltd. and having a molecular weight of 192.3)
Acid Catalyst

JP-508 (2-ethylhexyl acid phosphate, manufactured by Johoku Chemical Co., Ltd.)

Acetic acid (manufactured by Tokyo Chemical Industry Co., Ltd.)
Diluting solvent

PGME (propylene glycol monomethyl ether, manufactured by Nippon Nyukazai Co., Ltd. and having a molecular weight of 90.1)

EGiPE (ethylene glycol monoisopropyl ether, manufactured by Nippon Nyukazai Co., Ltd. and having a molecular weight of 104.1)

BuAc (butyl acetate, manufactured by KISHIDA CHEMICAL Co., Ltd. and having a molecular weight of 116.2)

MIBK (methyl isobutyl ketone, manufactured by Mitsubishi Chemical Corporation and having a molecular weight of 100.2)

Examples and Comparative Examples measured various physical properties by the following method.

(Measurement of Solid Content)

Approximately 0.2 g of a solution of synthesized organopolysiloxane or a solution of acrylic silicon was measured out and poured into an aluminum cup. Next, approximately 2 g of acetone was measured out and mixed with the solution, so that a homogeneous solution was obtained. The aluminum cup was placed in a hot air dryer at 105° C. for 1 hour so that the acetone and a diluting solvent were volatilized. Thereafter, the aluminum cup was taken out and was left standing until the aluminum cup was cooled to a room temperature. Then, a weight of the aluminum cup thus cooled was measured. Subsequently, a solid content (% by weight) was calculated based on the following expression: “(weight after drying−weight of aluminum cup)/(weight of solution of organopolysiloxane or solution of acrylic silicon−weight of aluminum cup)×100”

(Measurement of Number Average Molecular Weight)

A number average molecular weight was measured by use of GPC. Specifically, the number average molecular weight was measured by using HLC-8320GPC (manufactured by TOSOH CORPORATION) as a solution sending system, using TSK-GEL H type (manufactured by TOSOH CORPORATION) as a column, and using THF as a solvent, and the number average molecular weight was calculated in terms of a molecular weight of polystyrene.

(23° C. Storage Gelation Time (Time Required for Gelation of Composite Resin Stored at 23° C.))

After a composite resin was synthesized, the composite resin was left standing in a thermostatic chamber set at 23° C., and a time required for gelation of the composite resin was measured.

(80° C. Storage Gelation Time (Time Required for Gelation of Composite Resin Stored at 80° C.))

After a composite resin was synthesized, the composite resin was left standing in a thermostatic chamber set at 80° C., and a time required for gelation of the composite resin was measured.

(Transparency of Coated Film)

It was confirmed by visual inspection whether a cured coated film of a composite resin was transparent or turbid in white.

(Initial Adhesion)

Within one hour after formation of a cured coated film of a composite resin on a base material, the cured coated film was cut in with a utility knife so that a matrix of 100 cells (10 rows×10 columns) each measuring 1 mm square was formed on the cured coated film. Next, Scotch tape (Registered Trademark) manufactured by Nichiban Co., Ltd. was applied to the cured coated film thus cut in, and then the Scotch tape was vigorously peeled upward at an angle of 90° with respect to the cured coated film, so that it was observed by visual inspection whether the cured coated film was peeled from the base material. Then, point rating was carried out assuming that 100 points are scored for a case where the cured coated film completely adheres to the base material (all the cured coated film is unpeeled from the base material), 0 point is scored for a case where all the cured coated film has been peeled from the base material, and each cell corresponds to 1 point.

(Boiling Water 1 Hr Adhesion (Adhesion after Immersion in Boiling Water for 1 Hour))

A laminate including a cured coated film of a composite resin was immersed in boiling water for 1 hour. Thereafter, the water was slightly drained immediately after the laminate was taken out, and evaluation was carried out by carrying out observation as in the case of the observation carried out in the initial adhesion.

(Boiling Water 1 Hr Crack (Appearance or Nonappearance of Crack after Immersion in Boiling Water for 1 Hour))

A laminate including a cured coated film of a composite resin was immersed in boiling water for 1 hour. Thereafter, the laminate was taken out, and it was observed by visual inspection whether a crack appeared in the cured coated film. Then, a case where no crack appeared in the cured coated film was evaluated as “Good (G),” and a case where a crack appeared in the cured coated film was evaluated as “Poor (P).”

(Boiling Water 2 Hr Adhesion (Adhesion after Immersion in Boiling Water for 2 Hours))

A laminate including a cured coated film of a composite resin was immersed in boiling water for 2 hours. Thereafter, the water was slightly drained immediately after the laminate was taken out, and evaluation was carried out by carrying out observation as in the case of the observation carried out in the initial adhesion.

(Boiling Water 2 Hr Crack (Appearance or Nonappearance of Crack after Immersion in Boiling Water for 2 Hours))

A laminate including a cured coated film of a composite resin was immersed in boiling water for 2 hours. Thereafter, the laminate was taken out, and it was observed by visual inspection whether a crack appeared in the cured coated film. Then, a case where no crack appeared in the cured coated film was evaluated as “Good (G),” and a case where a crack appeared in the cured coated film was evaluated as “Poor (P).”

(Alkali Resistance)

Onto a cured coated film of a composite resin, 0.5 mL of a 0.1 N aqueous sodium hydroxide solution was dropped. Then, the cured coated film onto which the aqueous sodium hydroxide solution had been dropped was capped so that water would not volatilize. Next, the cured coated film was heated at 55° C. for 4 hours. Thereafter, the aqueous sodium hydroxide solution was wiped off the cured coated film, and it was observed by visual inspection whether the cured coated film was damaged. Then, a case where a faint trace of the drop of the aqueous sodium hydroxide solution remained on a surface of the cured coated film but the surface was not damaged was evaluated as “Good (G),” and a case where the surface of the cured coated film was damaged was evaluated as “Poor (P).”

(Resistance to Nail Scratch)

Against a cured coated film of a composite resin, a nail was pressed at an angle of approximately 90°. Then, the cured coated film was moved back and forth in a transverse direction several times under a load of approximately 500 g, and it was observed by visual inspection whether a scratch was made on the cured coated film. Then, a case where no scratch was made on the cured coated film was evaluated as “Good (G),” and a case where a scratch was made on the cured coated film was evaluated as “Poor (P).”

(200° C. 1 Hr Crack (Appearance or Nonappearance of Crack after Heating at 200° C. for 1 Hour))

A cured coated film of a composite resin was placed and heated in a hot air dryer at 200° C. for 1 hour. Thereafter, the cured coated film was immediately taken out. Immediately after the cured coated film was taken out, it was observed by visual inspection whether a crack appeared in the cured coated film. Then, a case where no crack appeared in the cured coated film was evaluated as “Good (G),” and a case where a crack appeared in the cured coated film was evaluated as “Poor (P).”

(200° C.→5° C. Cooling Crack (Appearance or Nonappearance of Crack after Cooling from 200° C. to 5° C.))

A cured coated film of a composite resin was placed and heated in a hot air dryer at 200° C. for 1 hour. Thereafter, the cured coated film was immediately taken out and placed in a thermostatic machine at 5° C. for 10 minutes so as to be cooled. Thereafter, the cured coated film was immediately taken out. Immediately after the cured coated film was taken out, it was observed by visual inspection whether a crack appeared in the cured coated film. Then, a case where no crack appeared in the cured coated film was evaluated as “Good (G),” and a case where a crack appeared in the cured coated film was evaluated as “Poor (P).”

(300° C. 30 Min Crack (Appearance or Nonappearance of Crack after Heating at 300° C. for 30 Minutes))

A cured coated film of a composite resin was placed and heated in a hot air dryer at 300° C. for 30 minutes. Thereafter, the cured coated film was immediately taken out. Immediately after the cured coated film was taken out, it was observed by visual inspection whether a crack appeared in the cured coated film. Then, a case where no crack appeared in the cured coated film was evaluated as “Good (G),” and a case where a crack appeared in the cured coated film was evaluated as “Poor (P).”

### Examples 1 to 11 of Production of Organopolysiloxane (a1) (Production Examples 1 to 11)

A blended product obtained by blending, in respective amounts shown in Table 1, organotrialkoxysilane, an acid catalyst, and water which had the respective compositions shown in Table 1 was fed into a reactor including a stirrer, a thermometer, and a reflux condenser. Then, the blended product was stirred at a room temperature for 1 hour. Thereafter, the blended product was heated to 50° C. and stirred for 12 hours, so that a condensate was obtained. A solid content of the obtained condensate which had not been distilled was measured, and then the condensate was distilled under reduced pressure by use of an evaporator and concentrated so that the solid content would be 80% by weight. Next, a diluting solvent whose composition and blended amount are shown in Table 1 was added to a resultant concentrate so that the concentrate to which the diluting solvent was added was adjusted to have a solid content of 50% by weight. A solution of organopolysiloxane was thus obtained. A number average molecular weight of synthesized organopolysiloxane (a1) was measured. Table 1 shows respective results of Production Examples 1 to 11.

TABLE 1

| | | Prod. | Prod. | Prod. | Prod. | Prod. | Prod. | Prod. | Prod. | Prod. | Prod. | Prod. |
|---|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
| Organo- | MTMS (g) | 100 | 100 | 100 | 100 | 100 | | | 100 | 100 | 100 | 100 |
| trialkoxysilane | ETMS (g) | | | | | | 100 | | | | | |
| | HTMS (g) | | | | | | | 100 | | | | |
| Water | Water (g) | 39.65 | 39.65 | 39.65 | 39.65 | 39.65 | 35.93 | 26.16 | 23.79 | 31.72 | 59.47 | 79.3 |
| Acid | JP-508 (g) | 0.010 | 0.010 | 0.010 | 0.010 | | 0.010 | 0.010 | 0.010 | 0.010 | 0.010 | 0.010 |
| catalyst | Acetic | | | | | 0.01 | | | | | | |
| | acid (g) | | | | | | | | | | | |
| Solid | (Before | 35.7 | 35.7 | 35.7 | 35.7 | 36.1 | 35.7 | 35.7 | 37.2 | 37.5 | 31.6 | 27.5 |
| content | distillation) | | | | | | | | | | | |
| | (% by | | | | | | | | | | | |
| | weight) | | | | | | | | | | | |
| Diluting | PGME (g) | 37.39 | | | | 37.81 | 36.4 | 33.78 | 34.54 | 37.05 | 37.8 | 36.98 |
| solvent | EGiPE (g) | | 37.39 | | | | | | | | | |
| | BuAc (g) | | | 37.39 | | | | | | | | |
| | MIBK (g) | | | | 37.39 | | | | | | | |
| Solid | (After | | | | | | | | | | | |
| content | adjustment) | | | | | | | | | | | |
| Number average | | 980 | 980 | 980 | 980 | 920 | 980 | 980 | 1000 | 1100 | 990 | 950 |
| molecular weight | | | | | | | | | | | | |

“Prod. Ex.” stands for “Production Example”.

### Examples 1 to 23 of Synthesis of Acrylic Silicon (a2) (Synthesis Examples 1 to 23)

An (A) component whose composition and blended amount are shown in Table 2 was fed into a reactor including a stirrer, a thermometer, a reflux condenser, a nitrogen gas inlet tube, and a dropping funnel. Then, the (A) component was heated to 110° C. while a nitrogen gas was being introduced into the reactor. Thereafter, onto the (A) component, a (B) component whose composition and blended amount are shown in Table 2 was dropped from the dropping funnel at a constant velocity over 5 hours. Next, onto a resultant reaction solution, a (C) component whose composition and blended amount are shown in Table 2 was dropped from the dropping funnel at a constant velocity over 1 hour. Then, the reaction solution onto which the (C) component had been dropped continued to be stirred at 110° C. for 2 hours, so that a solution of acrylic silicon was obtained. A number average molecular weight of synthesized acrylic silicon (a2) was measured. Table 2 shows respective results of Synthesis Examples 1 to 23. Note that the solution of acrylic silicon was diluted with a diluting solvent so as to have a solid content of 50% by weight.

TABLE 2

| | | | Syn. | Syn. | Syn. | Syn. | Syn. | Syn. |
|---|---|---|---|---|---|---|---|---|
| | | | Ex. 1 | Ex. 2 | Ex. 3 | Ex. 4 | Ex. 5 | Ex. 6 |
| (A) | Diluting | PGME (g) | 53.4 | 52.0 | 52.0 | 51.9 | 51.9 | 51.2 |
| | solvent | EGiPE (g) | | | | | | |
| | | BuAc (g) | | | | | | |
| | | MIBK (g) | | | | | | |
| (B) | Acrylic | A-174 (g) | 4.0 | 4.0 | 6.0 | 8.0 | 12.0 | 4.0 |
| | silicon | MMA (g) | 96.0 | 96.0 | 94.0 | 92.0 | 88.0 | 96.0 |
| | | Z-6033 (g) | | | | | | |
| | | Y-9936 (g) | | | | | | |
| | | BA (g) | | | | | | |
| | | BMA (g) | | | | | | |
| | | AA (g) | | | | | | |
| | | HEMA (g) | | | | | | |
| | Polymerization | V59 (g) | 6.6 | 3.8 | 3.7 | 3.7 | 3.6 | 2.3 |
| | initiator | | | | | | | |
| | Diluting | PGME (g) | | | | | | |
| | solvent | EGiPE (g) | | | | | | |
| | | BuAc (g) | | | | | | |
| | | MIBK (g) | 33.7 | 33.0 | 33.0 | 33.0 | 33.0 | 32.5 |
| (C) | Polymerization | V59 | 0.2 | 0.2 | 0.2 | 0.2 | 0.2 | 0.2 |
| | initiator | | | | | | | |
| | Diluting | PGME (g) | 19.7 | 19.0 | 19.0 | 18.9 | 18.9 | 18.7 |
| | solvent | EGiPE (g) | | | | | | |
| | | BuAc (g) | | | | | | |
| | | MIBK (g) | | | | | | |
| | Solid content | | 50 | 50 | 50 | 50 | 50 | 50 |
| | (% by weight) | | | | | | | |
| | Number average | | 3400 | 5100 | 5300 | 5400 | 5400 | 8350 |
| | molecular weight | | | | | | | |
| | | | Syn. | Syn. | Syn. | Syn. | Syn. | Syn. |
| | | | Ex. 7 | Ex. 8 | Ex. 9 | Ex. 10 | Ex. 11 | Ex. 12 |
| (A) | Diluting | PGME (g) | 50.8 | 50.6 | 50.6 | 50.6 | | |
| | solvent | EGiPE (g) | | | | | 52.0 | |
| | | BuAc (g) | | | | | | 52.0 |
| | | MIBK (g) | | | | | | |
| (B) | Acrylic | A-174 (g) | 4.0 | 2.0 | 7.0 | 12.0 | 4.0 | 4.0 |
| | silicon | MMA (g) | 96.0 | 98.0 | 93.0 | 88.0 | 96.0 | 96.0 |
| | | Z-6033 (g) | | | | | | |
| | | Y-9936 (g) | | | | | | |
| | | BA (g) | | | | | | |
| | | BMA (g) | | | | | | |
| | | AA (g) | | | | | | |
| | | HEMA (g) | | | | | | |
| | Polymerization | V59 (g) | 1.3 | 1.0 | 0.9 | 0.9 | 3.8 | 3.8 |
| | initiator | | | | | | | |
| | Diluting | PGME (g) | | | | | | |
| | solvent | EGiPE (g) | | | | | | |
| | | BuAc (g) | | | | | | |
| | | MIBK (g) | 32.0 | 32.0 | 32.0 | 32.0 | 33.0 | 33.0 |
| (C) | Polymerization | V59 | 0.2 | 0.2 | 0.2 | 0.2 | 0.2 | 0.2 |
| | initiator | | | | | | | |
| | Diluting | PGME (g) | 18.8 | 18.6 | 18.6 | 18.5 | | |
| | solvent | EGiPE (g) | | | | | 19.0 | |
| | | BuAc (g) | | | | | | 19.0 |
| | | MIBK (g) | | | | | | |
| | Solid content | | 50 | 50 | 50 | 50 | 50 | 50 |
| | (% by weight) | | | | | | | |
| | Number average | | 11200 | 14300 | 16300 | 15200 | 5100 | 5200 |
| | molecular weight | | | | | | | |
| | | | Syn. | Syn. | Syn. | Syn. | Syn. | Syn. |
| | | | Ex. 13 | Ex. 14 | Ex. 15 | Ex. 16 | Ex. 17 | Ex. 18 |
| (A) | Diluting | PGME (g) | | 52.0 | 52.0 | 51.9 | 51.8 | 51.4 |
| | solvent | EGiPE (g) | | | | | | |
| | | BuAc (g) | | | | | | |
| | | MIBK (g) | 52.0 | | | | | |
| (B) | Acrylic | A-174 (g) | 4.0 | | | 4.0 | 4.0 | 4.0 |
| | silicon | MMA (g) | 96.0 | 96.0 | 96.0 | 77.0 | 58.0 | 67.0 |
| | | Z-6033 (g) | | 4.0 | | | | |
| | | Y-9936 (g) | | | 4.0 | | | |
| | | BA (g) | | | | 19.0 | 38.0 | |
| | | BMA (g) | | | | | | 29.0 |
| | | AA (g) | | | | | | |
| | | HEMA (g) | | | | | | |
| | Polymerization | V59 (g) | 3.8 | 3.8 | 3.7 | 3.6 | 3.4 | 2.6 |
| | initiator | | | | | | | |
| | Diluting | PGME (g) | | | | | | |
| | solvent | EGiPE (g) | | | | | | |
| | | BuAc (g) | | | | | | |
| | | MIBK (g) | 33.0 | 33.0 | 33.0 | 33.0 | 33.0 | 33.0 |
| (C) | Polymerization | V59 | 0.2 | 0.2 | 0.2 | 0.2 | 0.2 | 0.2 |
| | initiator | | | | | | | |
| | Diluting | PGME (g) | | 19.0 | 19.0 | 18.9 | 18.8 | 18.4 |
| | solvent | EGiPE (g) | | | | | | |
| | | BuAc (g) | | | | | | |
| | | MIBK (g) | 19.0 | | | | | |

| | | | | | | |
|---|---|---|---|---|---|---|
| Solid content | 50 | 50 | 50 | 50 | 50 | 50 |
| (% by weight) | | | | | | |
| Number average | 4800 | 5050 | 5300 | 4600 | 4200 | 5300 |
| molecular weight | | | | | | |

| | | | Syn. | Syn. | Syn. | Syn. | Syn. |
|---|---|---|---|---|---|---|---|
| | | | Ex. 19 | Ex. 20 | Ex. 21 | Ex. 22 | Ex. 23 |
| (A) | Diluting | PGME (g) | 51.9 | 51.6 | 52.0 | 52.0 | 51.9 |
| | solvent | EGiPE (g) | | | | | |
| | | BuAc (g) | | | | | |
| | | MIBK (g) | | | | | |
| (B) | Acrylic | A-174 (g) | 4.0 | 4.0 | 2.0 | 3.0 | 10.0 |
| | silicon | MMA (g) | 91.0 | 77.0 | 98.0 | 97.0 | 90.0 |
| | | Z-6033 (g) | | | | | |
| | | Y-9936 (g) | | | | | |
| | | BA (g) | | | | | |
| | | BMA (g) | | | | | |
| | | AA (g) | 5.0 | | | | |
| | | HEMA (g) | | 19.0 | | | |
| | Polymerization | V59 (g) | 3.6 | 3.0 | 3.8 | 3.8 | 3.6 |
| | initiator | | | | | | |
| | Diluting | PGME (g) | | | | | |
| | solvent | EGiPE (g) | | | | | |
| | | BuAc (g) | | | | | |
| | | MIBK (g) | 33.0 | 32.8 | 33.0 | 33.0 | 33.0 |
| (C) | Polymerization | V59 | 0.2 | 0.2 | 0.2 | 0.2 | 0.2 |
| | initiator | | | | | | |
| | Diluting | PGME (g) | 18.9 | 18.8 | 19.0 | 19.0 | 18.9 |
| | solvent | EGiPE (g) | | | | | |
| | | BuAc (g) | | | | | |
| | | MIBK (g) | | | | | |

| | | | | | |
|---|---|---|---|---|---|
| Solid content | 50 | 50 | 50 | 50 | 50 |
| (% by weight) | | | | | |
| Number average | 6700 | 5900 | 4900 | 5100 | 5400 |
| molecular weight | | | | | |

“Syn. Ex.” stands for “Synthesis Example”.

### Examples 1 to 41 of Preparation of Composite Resin (A) (Preparation Examples 1 to 41)

The solution of organopolysiloxane which solution had been obtained in each of the above Production Examples and had the composition shown in Table 3 or 4, the solution of acrylic silicon which solution had been obtained in each of the above Synthesis Examples and had the composition shown in Table 3 or 4, the acid catalyst whose composition is shown in Table 3 or 4, and the diluting solvent whose composition is shown in Table 3 or 4 were fed, in respective blended amounts shown in Table 3 or 4, into a reactor including a stirrer, a thermometer, and a reflux condenser. Then, a resultant blended product was stirred at 80° C. for 6 hours so as to be subjected to a compositing reaction, so that a composite resin (A) was obtained at a compositing concentration (solid content concentration obtained after the compositing reaction was carried out) shown in Table 3 or 4. Various physical properties of the composite resin (A) thus obtained were measured. Tables 3 and 4 show respective results of Preparation Examples 1 to 41.

Note that, since each of the solution of organopolysiloxane which solution is shown in Table 3 or 4 and the solution of acrylic silicon which solution is shown in Table 3 or 4 had a solid content of 50% by weight, a polysiloxane ratio (a compositing ratio of the organopolysiloxane (a1)) was calculated based on the following expression: “blended amount of solution of organopolysiloxane/(blended amount of solution of organopolysiloxane+blended amount of solution of acrylic silicon)×100”

Similarly, the compositing concentration was calculated based on the following expression: “blended amount of solution of organopolysiloxane×0.5+blended amount of solution of acrylic silicon×0.5)/total amount of blended product×100”

In preparation of the composite resin (A), a composite resin which had gelated during the compositing reaction was not used for subsequent formulation of a coating solution. Specifically, Preparation Example 14 fed the solution of organopolysiloxane, the solution of acrylic silicon, etc. into the reactor, heated a resultant mixture to 80° C. first so as to stir the mixture for 10 minutes, then distilled the mixture under reduced pressure until 16.6 g of the diluting solvent volatilized (see Table 3), and subsequently stirred a resultant blended product at 80° C. for 6 hours so as to subject the blended product to the compositing reaction, so that the composite resin gelated. In each of Preparation Examples 17 and 18, the composite resin gelated while the blended product was stirred at 80° C. for 6 hours so as to be subjected to the compositing reaction. Thus, the composite resin which had been prepared in each of Preparation Examples 14, 17, and 18 was not used for the subsequent formulation of the coating solution.

TABLE 3

| | | Prep. | Prep. | Prep. | Prep. | Prep. |
|---|---|---|---|---|---|---|
| | | Ex. 1 | Ex. 2 | Ex. 3 | Ex. 4 | Ex. 5 |
| Organo- | Prod. Ex. 1 (g) | 70 | 70 | 70 | 70 | 70 |
| polysiloxane | Prod. Ex. 2 (g) | | | | | |
| | Prod. Ex. 3 (g) | | | | | |
| | Prod. Ex. 4 (g) | | | | | |
| Acrylic | Syn. Ex. 1 (g) | 30 | | | | |
| silicon | Syn. Ex. 2 (g) | | 30 | | | |
| | Syn. Ex. 3 (g) | | | 30 | | |
| | Syn. Ex. 4 (g) | | | | 30 | |
| | Syn. Ex. 5 (g) | | | | | 30 |
| | Syn. Ex. 6 (g) | | | | | |
| | Syn. Ex. 7 (g) | | | | | |
| | Syn. Ex. 8 (g) | | | | | |
| | Syn. Ex. 9 (g) | | | | | |
| | Syn. Ex. 10 (g) | | | | | |
| | Syn. Ex. 11 (g) | | | | | |
| | Syn. Ex. 12 (g) | | | | | |
| | Syn. Ex. 13 (g) | | | | | |
| Acid | JP-508 (g) | 0.10 | 0.10 | 0.10 | 0.10 | 0.10 |
| catalyst | | | | | | |
| Diluting | PGME (g) | 25.2 | 25.2 | 25.2 | 25.2 | 25.2 |
| solvent | EGiPE (g) | | | | | |
| | BuAc (g) | | | | | |
| | MIBK (g) | | | | | |
| | Compositing | 40 | 40 | 40 | 40 | 40 |
| | concentration | | | | | |
| | (% by weight) | | | | | |
| | Polysiloxane | 70 | 70 | 70 | 70 | 70 |
| | ratio (% by | | | | | |
| | weight) | | | | | |
| | 23° C. storage | — | — | — | — | 2M |
| | gelation time | | | | | |
| | 80° C. storage | 100 Hr> | 100 Hr> | 100 Hr> | 100 Hr> | 24 Hr |
| | gelation time | | | | | |

| | | Prep. | Prep. | Prep. | Prep. | Prep. |
|---|---|---|---|---|---|---|
| | | Ex. 6 | Ex. 7 | Ex. 8 | Ex. 9 | Ex. 10 |
| Organo- | Prod. Ex. 1 (g) | 70 | 70 | 70 | 70 | 70 |
| polysiloxane | Prod. Ex. 2 (g) | | | | | |
| | Prod. Ex. 3 (g) | | | | | |
| | Prod. Ex. 4 (g) | | | | | |
| Acrylic | Syn. Ex. 1 (g) | | | | | |
| silicon | Syn. Ex. 2 (g) | | | | | |
| | Syn. Ex. 3 (g) | | | | | |
| | Syn. Ex. 4 (g) | | | | | |
| | Syn. Ex. 5 (g) | | | | | |
| | Syn. Ex. 6 (g) | 30 | | | | |
| | Syn. Ex. 7 (g) | | 30 | | | |
| | Syn. Ex. 8 (g) | | | 30 | | |
| | Syn. Ex. 9 (g) | | | | 30 | |
| | Syn. Ex. 10 (g) | | | | | 30 |
| | Syn. Ex. 11 (g) | | | | | |
| | Syn. Ex. 12 (g) | | | | | |
| | Syn. Ex. 13 (g) | | | | | |
| Acid | JP-508 (g) | 0.10 | 0.10 | 0.10 | 0.10 | 0.10 |
| catalyst | | | | | | |
| Diluting | PGME (g) | 25.2 | 25.2 | 25.2 | 25.2 | 25.2 |
| solvent | EGiPE (g) | | | | | |
| | BuAc (g) | | | | | |
| | MIBK (g) | | | | | |
| | Compositing | 40 | 40 | 40 | 40 | 40 |
| | concentration | | | | | |
| | (% by weight) | | | | | |
| | Polysiloxane | 70 | 70 | 70 | 70 | 70 |
| | ratio (% by | | | | | |
| | weight) | | | | | |
| | 23° C. storage | — | 24 Hr | 24 Hr | 24 Hr | 24 Hr |
| | gelation time | | | | | |
| | 80° C. storage | 100 Hr> | 3 Hr< | 3 Hr< | 3 Hr< | 3 Hr< |
| | gelation time | | | | | |
| | | Prep. | Prep. | Prep. | Prep. | Prep. |
| | | Ex. 11 | Ex. 12 | Ex. 13 | Ex. 14 | Ex. 15 |
| Organo- | Prod. Ex. 1 (g) | 70 | 70 | 70 | 70 | |
| polysiloxane | Prod. Ex. 2 (g) | | | | | 70 |
| | Prod. Ex. 3 (g) | | | | | |
| | Prod. Ex. 4 (g) | | | | | |
| Acrylic | Syn. Ex. 1 (g) | 30 | 30 | 30 | 30 | |
| silicon | Syn. Ex. 2 (g) | | | | | |
| | Syn. Ex. 3 (g) | | | | | |
| | Syn. Ex. 4 (g) | | | | | |
| | Syn. Ex. 5 (g) | | | | | |
| | Syn. Ex. 6 (g) | | | | | |
| | Syn. Ex. 7 (g) | | | | | |
| | Syn. Ex. 8 (g) | | | | | |
| | Syn. Ex. 9 (g) | | | | | |
| | Syn. Ex. 10 (g) | | | | | |
| | Syn. Ex. 11 (g) | | | | | 30 |
| | Syn. Ex. 12 (g) | | | | | |
| | Syn. Ex. 13 (g) | | | | | |
| Acid | JP-508 (g) | 0.10 | 0.10 | 0.10 | 0.10 | 0.10 |
| catalyst | | | | | | |
| Diluting | PGME (g) | 25.2 | 25.2 | 0.1 | −16.6 | |
| solvent | EGiPE (g) | | | | | 25.2 |
| | BuAc (g) | | | | | |
| | MIBK (g) | | | | | |
| | Compositing | 20 | 30 | 50 | 60 | 40 |
| | concentration | | | | | |
| | (% by weight) | | | | | |
| | Polysiloxane | 70 | 70 | 70 | 70 | 70 |
| | ratio (% by | | | | | |
| | weight) | | | | | |
| | 23° C. storage | — | — | — | — | — |
| | gelation time | | | | | |
| | 80° C. storage | 100 Hr> | 100 Hr> | 100 Hr> | — | 100 Hr> |
| | gelation time | | | | | |
| | | Prep. | Prep. | Prep. | Prep. | Prep. |
| | | Ex. 16 | Ex. 17 | Ex. 18 | Ex. 19 | Ex. 20 |
| Organo- | Prod. Ex. 1 (g) | | | 30 | 40 | 50 |
| polysiloxane | Prod. Ex. 2 (g) | | | | | |
| | Prod. Ex. 3 (g) | 70 | | | | |
| | Prod. Ex. 4 (g) | | 70 | | | |
| Acrylic | Syn. Ex. 1 (g) | | | 70 | 60 | 50 |
| silicon | Syn. Ex. 2 (g) | | | | | |
| | Syn. Ex. 3 (g) | | | | | |
| | Syn. Ex. 4 (g) | | | | | |
| | Syn. Ex. 5 (g) | | | | | |
| | Syn. Ex. 6 (g) | | | | | |
| | Syn. Ex. 7 (g) | | | | | |
| | Syn. Ex. 8 (g) | | | | | |
| | Syn. Ex. 9 (g) | | | | | |
| | Syn. Ex. 10 (g) | | | | | |
| | Syn. Ex. 11 (g) | | | | | |
| | Syn. Ex. 12 (g) | 30 | | | | |
| | Syn. Ex. 13 (g) | | 30 | | | |
| Acid | JP-508 (g) | 0.10 | 0.10 | 0.10 | 0.10 | 0.10 |
| catalyst | | | | | | |
| Diluting | PGME (g) | | | 25.2 | 25.2 | 25.2 |
| solvent | EGiPE (g) | | | | | |
| | BuAc (g) | 25.2 | | | | |
| | MIBK (g) | | 25.2 | | | |
| | Compositing | 40 | 40 | 40 | 40 | 40 |
| | concentration | | | | | |
| | (% by weight) | | | | | |
| | Polysiloxane | 70 | 70 | 70 | 40 | 50 |
| | ratio (% by | | | | | |
| | weight) | | | | | |
| | 23° C. storage | — | — | — | — | — |
| | gelation time | | | | | |
| | 80° C. storage | — | — | 100 Hr> | 100 Hr> | 100 Hr> |
| | gelation time | | | | | |

“Prod. Ex.” stands for “Production Example”.
“Syn. Ex.” stands for “Synthesis Example”.
“Prep. Ex.” stands for “Preparation Example”.

TABLE 4

| | | Prep. | Prep. | Prep. | Prep. | Prep. |
|---|---|---|---|---|---|---|
| | | Ex. 21 | Ex. 22 | Ex. 23 | Ex. 24 | Ex. 25 |
| Organo- | Prod. Ex. 1 (g) | 60 | 80 | 90 | 100 | |
| polysiloxane | Prod. Ex. 5 (g) | | | | | 70 |
| | Prod. Ex. 6 (g) | | | | | |
| | Prod. Ex. 7 (g) | | | | | |
| | Prod. Ex. 8 (g) | | | | | |
| | Prod. Ex. 9 (g) | | | | | |
| | Prod. Ex. 10 (g) | | | | | |
| | Prod. Ex. 11 (g) | | | | | |
| Acrylic | Syn. Ex. 1 (g) | | | | | |
| silicon | Syn. Ex. 2 (g) | 40 | 20 | 10 | 0 | 30 |
| | Syn. Ex. 14 (g) | | | | | |
| | Syn. Ex. 15 (g) | | | | | |
| | Syn. Ex. 16 (g) | | | | | |
| | Syn. Ex. 17 (g) | | | | | |
| | Syn. Ex. 18 (g) | | | | | |
| | Syn. Ex. 19 (g) | | | | | |
| | Syn. Ex. 20 (g) | | | | | |
| | Syn. Ex. 21 (g) | | | | | |
| | Syn. Ex. 22 (g) | | | | | |
| | Syn. Ex. 23 (g) | | | | | |
| Acid | JP-508 (g) | 0.10 | 0.10 | 0.10 | 0.10 | |
| catalyst | Acetic acid (g) | | | | | 0.10 |
| Diluting | PGME (g) | 25.2 | 25.2 | 25.2 | 25.2 | 25.2 |
| solvent | Compositing | 40 | 40 | 40 | 40 | 40 |
| | concentration | | | | | |
| | (% by weight) | | | | | |
| | Polysiloxane | 60 | 80 | 90 | 100 | 70 |
| | ratio (% by | | | | | |
| | weight) | | | | | |
| | 23° C. storage | — | 1M | 1M | — | — |
| | gelation time | | | | | |
| | 80° C. storage | 100 Hr> | 12 Hr | 12 Hr | 100 Hr> | 100 Hr> |
| | gelation time | | | | | |
| | | Prep. | Prep. | Prep. | Prep. | Prep. |
| | | Ex. 26 | Ex. 27 | Ex. 28 | Ex. 29 | Ex. 30 |
| Organo- | Prod. Ex. 1 (g) | | | 70 | 70 | 70 |
| polysiloxane | Prod. Ex. 5 (g) | | | | | |
| | Prod. Ex. 6 (g) | 70 | | | | |
| | Prod. Ex. 7 (g) | | 70 | | | |
| | Prod. Ex. 8 (g) | | | | | |
| | Prod. Ex. 9 (g) | | | | | |
| | Prod. Ex. 10 (g) | | | | | |
| | Prod. Ex. 11 (g) | | | | | |
| Acrylic | Syn. Ex. 1 (g) | | | | | |
| silicon | Syn. Ex. 2 (g) | 30 | 30 | | | |
| | Syn. Ex. 14 (g) | | | 30 | | |
| | Syn. Ex. 15 (g) | | | | 30 | |
| | Syn. Ex. 16 (g) | | | | | 30 |
| | Syn. Ex. 17 (g) | | | | | |
| | Syn. Ex. 18 (g) | | | | | |
| | Syn. Ex. 19 (g) | | | | | |
| | Syn. Ex. 20 (g) | | | | | |
| | Syn. Ex. 21 (g) | | | | | |
| | Syn. Ex. 22 (g) | | | | | |
| | Syn. Ex. 23 (g) | | | | | |
| Acid | JP-508 (g) | 0.10 | 0.10 | 0.10 | 0.10 | 0.10 |
| catalyst | Acetic acid (g) | | | | | |
| Diluting | PGME (g) | 25.2 | 25.2 | 25.2 | 25.2 | 25.2 |
| solvent | Compositing | 40 | 40 | 40 | 40 | 40 |
| | concentration | | | | | |
| | (% by weight) | | | | | |
| | Polysiloxane | 70 | 70 | 70 | 70 | 70 |
| | ratio (% by | | | | | |
| | weight) | | | | | |
| | 23° C. storage | — | — | — | — | — |
| | gelation time | | | | | |
| | 80° C. storage | 100 Hr> | 100 Hr> | 100 Hr> | 100 Hr> | 100 Hr> |
| | gelation time | | | | | |
| | | Prep. | Prep. | Prep. | Prep. | Prep. |
| | | Ex. 31 | Ex. 32 | Ex. 33 | Ex. 34 | Ex. 35 |
| Organo- | Prod. Ex. 1 (g) | 70 | 70 | 70 | 70 | 70 |
| polysiloxane | Prod. Ex. 5 (g) | | | | | |
| | Prod. Ex. 6 (g) | | | | | |
| | Prod. Ex. 7 (g) | | | | | |
| | Prod. Ex. 8 (g) | | | | | |
| | Prod. Ex. 9 (g) | | | | | |
| | Prod. Ex. 10 (g) | | | | | |
| | Prod. Ex. 11 (g) | | | | | |
| Acrylic | Syn. Ex. 1 (g) | | | | | |
| silicon | Syn. Ex. 2 (g) | | | | | |
| | Syn. Ex. 14 (g) | | | | | |
| | Syn. Ex. 15 (g) | | | | | |
| | Syn. Ex. 16 (g) | | | | | |
| | Syn. Ex. 17 (g) | 30 | | | | |
| | Syn. Ex. 18 (g) | | 30 | | | |
| | Syn. Ex. 19 (g) | | | 30 | | |
| | Syn. Ex. 20 (g) | | | | 30 | |
| | Syn. Ex. 21 (g) | | | | | 30 |
| | Syn. Ex. 22 (g) | | | | | |
| | Syn. Ex. 23 (g) | | | | | |
| Acid | JP-508 (g) | 0.10 | 0.10 | 0.10 | 0.10 | 0.10 |
| catalyst | Acetic acid (g) | | | | | |
| Diluting | PGME (g) | 25.2 | 25.2 | 25.2 | 25.2 | 25.2 |
| solvent | Compositing | 40 | 40 | 40 | 40 | 40 |
| | concentration | | | | | |
| | (% by weight) | | | | | |
| | Polysiloxane | 70 | 70 | 70 | 70 | 70 |
| | ratio (% by | | | | | |
| | weight) | | | | | |
| | 23° C. storage | — | — | — | — | — |
| | gelation time | | | | | |
| | 80° C. storage | 100 Hr> | 100 Hr> | 100 Hr> | 100 Hr> | 100 Hr> |
| | gelation time | | | | | |

| | | Prep. | Prep. | Prep. | Prep. | Prep. | Prep. |
|---|---|---|---|---|---|---|---|
| | | Ex. 36 | Ex. 37 | Ex. 38 | Ex. 39 | Ex. 40 | Ex. 41 |
| Organo- | Prod. Ex. 1 (g) | 70 | 70 | | | | |
| polysiloxane | Prod. Ex. 5 (g) | | | | | | |
| | Prod. Ex. 6 (g) | | | | | | |
| | Prod. Ex. 7 (g) | | | | | | |
| | Prod. Ex. 8 (g) | | | 70 | | | |
| | Prod. Ex. 9 (g) | | | | 70 | | |
| | Prod. Ex. 10 (g) | | | | | 70 | |
| | Prod. Ex. 11 (g) | | | | | | 70 |
| Acrylic | Syn. Ex. 1 (g) | | | | | | |
| silicon | Syn. Ex. 2 (g) | | | 30 | 30 | 30 | 30 |
| | Syn. Ex. 14 (g) | | | | | | |
| | Syn. Ex. 15 (g) | | | | | | |
| | Syn. Ex. 16 (g) | | | | | | |
| | Syn. Ex. 17 (g) | | | | | | |
| | Syn. Ex. 18 (g) | | | | | | |
| | Syn. Ex. 19 (g) | | | | | | |
| | Syn. Ex. 20 (g) | | | | | | |
| | Syn. Ex. 21 (g) | | | | | | |
| | Syn. Ex. 22 (g) | 30 | | | | | |
| | Syn. Ex. 23 (g) | | 30 | | | | |
| Acid | JP-508 (g) | 0.10 | 0.10 | 0.10 | 0.10 | 0.10 | 0.10 |
| catalyst | Acetic acid (g) | | | | | | |
| Diluting | PGME (g) | 25.2 | 25.2 | 25.2 | 25.2 | 25.2 | 25.2 |
| solvent | Compositing | 40 | 40 | 40 | 40 | 40 | 40 |
| | concentration | | | | | | |
| | (% by weight) | | | | | | |
| | Polysiloxane | 70 | 70 | 70 | 70 | 70 | 70 |
| | ratio (% by | | | | | | |
| | weight) | | | | | | |
| | 23° C. storage | — | 2M | — | — | — | |
| | gelation time | | | | | | |
| | 80° C. storage | 100 Hr> | 24 Hr | 100 Hr> | 100 Hr> | 100 Hr> | 100 Hr> |
| | gelation time | | | | | | |

“Prod. Ex.” stands for “Production Example”.
“Syn. Ex.” stands for “Synthesis Example”.
“Prep. Ex.” stands for “Preparation Example”.

### Examples of Formulation of Coating Solutions 1 to 38

A blended product obtained by blending, in respective amounts shown in Table 5 or 6, the composite resin (A) which had been obtained in each of Preparation Examples 1 to 13, 15, 16, and 19 to 41 and had the composition shown in Table 5 or 6 and the diluting solvent whose composition is shown in Table 5 or 6 was fed into a sample bottle and stirred by use of a magnetic stirrer for 5 minutes. Coating solutions 1 to 38 were thus formulated.

TABLE 5

| | | Coating | Coating | Coating | Coating | Coating |
|---|---|---|---|---|---|---|
| | | solution 1 | solution 2 | solution 3 | solution 4 | solution 5 |
| | Prep. Ex. 1 (g) | 5 | | | | |
| | Prep. Ex. 2 (g) | | 5 | | | |
| | Prep. Ex. 3 (g) | | | 5 | | |
| | Prep. Ex. 4 (g) | | | | 5 | |
| | Prep. Ex. 5 (g) | | | | | 5 |
| | Prep. Ex. 6 (g) | | | | | |
| | Prep. Ex. 7 (g) | | | | | |
| | Prep. Ex. 8 (g) | | | | | |
| | Prep. Ex. 9 (g) | | | | | |
| | Prep. Ex. 10 (g) | | | | | |
| | Prep. Ex. 11 (g) | | | | | |
| | Prep. Ex. 12 (g) | | | | | |
| | Prep. Ex. 13 (g) | | | | | |
| | Prep. Ex. 15 (g) | | | | | |
| | Prep. Ex. 18 (g) | | | | | |
| | Prep. Ex. 19 (g) | | | | | |
| | Prep. Ex. 20 (g) | | | | | |
| | Prep. Ex. 21 (g) | | | | | |
| | Prep. Ex. 22 (g) | | | | | |
| | Prep. Ex. 23 (g) | | | | | |
| Diluting | PGME (g) | 5 | 5 | 5 | 5 | 5 |
| solvent | EGiPE (g) | | | | | |

| | | Coating | Coating | Coating | Coating | Coating |
|---|---|---|---|---|---|---|
| | | solution 6 | solution 7 | solution 8 | solution 9 | solution 10 |
| | Prep. Ex. 1 (g) | | | | | |
| | Prep. Ex. 2 (g) | | | | | |
| | Prep. Ex. 3 (g) | | | | | |
| | Prep. Ex. 4 (g) | | | | | |
| | Prep. Ex. 5 (g) | | | | | |
| | Prep. Ex. 6 (g) | 5 | | | | |
| | Prep. Ex. 7 (g) | | 5 | | | |
| | Prep. Ex. 8 (g) | | | 5 | | |
| | Prep. Ex. 9 (g) | | | | 5 | |
| | Prep. Ex. 10 (g) | | | | | 5 |
| | Prep. Ex. 11 (g) | | | | | |
| | Prep. Ex. 12 (g) | | | | | |
| | Prep. Ex. 13 (g) | | | | | |
| | Prep. Ex. 15 (g) | | | | | |
| | Prep. Ex. 18 (g) | | | | | |
| | Prep. Ex. 19 (g) | | | | | |
| | Prep. Ex. 20 (g) | | | | | |
| | Prep. Ex. 21 (g) | | | | | |
| | Prep. Ex. 22 (g) | | | | | |
| | Prep. Ex. 23 (g) | | | | | |
| Diluting | PGME (g) | 5 | 5 | 5 | 5 | 5 |
| solvent | EGiPE (g) | | | | | |

| | | Coating | Coating | Coating | Coating | Coating |
|---|---|---|---|---|---|---|
| | | solution 11 | solution 12 | solution 13 | solution 14 | solution 15 |
| | Prep. Ex. 1 (g) | | | | | |
| | Prep. Ex. 2 (g) | | | | | |
| | Prep. Ex. 3 (g) | | | | | |
| | Prep. Ex. 4 (g) | | | | | |
| | Prep. Ex. 5 (g) | | | | | |
| | Prep. Ex. 6 (g) | | | | | |
| | Prep. Ex. 7 (g) | | | | | |
| | Prep. Ex. 8 (g) | | | | | |
| | Prep. Ex. 9 (g) | | | | | |
| | Prep. Ex. 10 (g) | | | | | |
| | Prep. Ex. 11 (g) | 5 | | | | |
| | Prep. Ex. 12 (g) | | 5 | | | |
| | Prep. Ex. 13 (g) | | | 5 | | |
| | Prep. Ex. 15 (g) | | | | 5 | |
| | Prep. Ex. 18 (g) | | | | | 5 |
| | Prep. Ex. 19 (g) | | | | | |
| | Prep. Ex. 20 (g) | | | | | |
| | Prep. Ex. 21 (g) | | | | | |
| | Prep. Ex. 22 (g) | | | | | |
| | Prep. Ex. 23 (g) | | | | | |
| Diluting | PGME (g) | 0 | 2.5 | 7.5 | | 5 |
| solvent | EGiPE (g) | | | | 5 | |
| | | Coating | Coating | Coating | Coating | Coating |
| | | solution 16 | solution 17 | solution 18 | solution 19 | solution 20 |
| | Prep. Ex. 1 (g) | | | | | |
| | Prep. Ex. 2 (g) | | | | | |
| | Prep. Ex. 3 (g) | | | | | |
| | Prep. Ex. 4 (g) | | | | | |
| | Prep. Ex. 5 (g) | | | | | |
| | Prep. Ex. 6 (g) | | | | | |
| | Prep. Ex. 7 (g) | | | | | |
| | Prep. Ex. 8 (g) | | | | | |
| | Prep. Ex. 9 (g) | | | | | |
| | Prep. Ex. 10 (g) | | | | | |
| | Prep. Ex. 11 (g) | | | | | |
| | Prep. Ex. 12 (g) | | | | | |
| | Prep. Ex. 13 (g) | | | | | |
| | Prep. Ex. 16 (g) | | | | | |
| | Prep. Ex. 18 (g) | | | | | |
| | Prep. Ex. 19 (g) | 5 | | | | |
| | Prep. Ex. 20 (g) | | 5 | | | |
| | Prep. Ex. 21 (g) | | | 5 | | |
| | Prep. Ex. 22 (g) | | | | 5 | |
| | Prep. Ex. 23 (g) | | | | | 5 |
| Diluting | PGME (g) | 5 | 5 | 5 | 5 | 5 |
| solvent | EGiPE (g) | | | | | |

“Prep. Ex.” stands for “Preparation Example”.

TABLE 6

| | | Coating | Coating | Coating | Coating | Coating |
|---|---|---|---|---|---|---|
| | | solution 24 | solution 25 | solution 26 | solution 27 | solution 28 |
| | Prep. Ex. 24 (g) | | | | | |
| | Prep. Ex. 25 (g) | | | | | |
| | Prep. Ex. 26 (g) | | | | | |
| | Prep. Ex. 27 (g) | 5 | | | | |
| | Prep. Ex. 28 (g) | | 5 | | | |
| | Prep. Ex. 29 (g) | | | 5 | | |
| | Prep. Ex. 30 (g) | | | | 5 | |
| | Prep. Ex. 31 (g) | | | | | 5 |
| | Prep. Ex. 32 (g) | | | | | |
| | Prep. Ex. 33 (g) | | | | | |
| | Prep. Ex. 34 (g) | | | | | |
| | Prep. Ex. 35 (g) | | | | | |
| | Prep. Ex. 36 (g) | | | | | |
| | Prep. Ex. 37 (g) | | | | | |
| | Prep. Ex. 38 (g) | | | | | |
| | Prep. Ex. 39 (g) | | | | | |
| | Prep. Ex. 40 (g) | | | | | |
| | Prep. Ex. 41 (g) | | | | | |
| Diluting | PGME (g) | 5 | 5 | 5 | 5 | 5 |
| solvent | | | | | | |
| | | Coating | Coating | Coating | Coating | Coating |
| | | solution 29 | solution 30 | solution 31 | solution 32 | solution 33 |
| | Prep. Ex. 24 (g) | | | | | |
| | Prep. Ex. 25 (g) | | | | | |
| | Prep. Ex. 26 (g) | | | | | |
| | Prep. Ex. 27 (g) | | | | | |
| | Prep. Ex. 28 (g) | | | | | |
| | Prep. Ex. 29 (g) | | | | | |
| | Prep. Ex. 30 (g) | | | | | |
| | Prep. Ex. 31 (g) | | | | | |
| | Prep. Ex. 32 (g) | 5 | | | | |
| | Prep. Ex. 33 (g) | | 5 | | | |
| | Prep. Ex. 34 (g) | | | 5 | | |
| | Prep. Ex. 35 (g) | | | | 5 | |
| | Prep. Ex. 36 (g) | | | | | 5 |
| | Prep. Ex. 37 (g) | | | | | |
| | Prep. Ex. 38 (g) | | | | | |
| | Prep. Ex. 39 (g) | | | | | |
| | Prep. Ex. 40 (g) | | | | | |
| | Prep. Ex. 41 (g) | | | | | |
| Diluting | PGME (g) | 5 | 5 | 5 | 5 | 5 |
| solvent | | | | | | |
| | | Coating | Coating | Coating | Coating | Coating |
| | | solution 34 | solution 35 | solution 36 | solution 37 | solution 38 |
| | Prep. Ex. 24 (g) | | | | | |
| | Prep. Ex. 25 (g) | | | | | |
| | Prep. Ex. 26 (g) | | | | | |
| | Prep. Ex. 27 (g) | | | | | |
| | Prep. Ex. 28 (g) | | | | | |
| | Prep. Ex. 29 (g) | | | | | |
| | Prep. Ex. 30 (g) | | | | | |
| | Prep. Ex. 31 (g) | | | | | |
| | Prep. Ex. 32 (g) | | | | | |
| | Prep. Ex. 33 (g) | | | | | |
| | Prep. Ex. 34 (g) | | | | | |
| | Prep. Ex. 35 (g) | | | | | |
| | Prep. Ex. 36 (g) | | | | | |
| | Prep. Ex. 37 (g) | 5 | | | | |
| | Prep. Ex. 38 (g) | | 5 | | | |
| | Prep. Ex. 39 (g) | | | 5 | | |
| | Prep. Ex. 40 (g) | | | | 5 | |
| | Prep. Ex. 41 (g) | | | | | 5 |
| Diluting | PGME (g) | 5 | 5 | 5 | 5 | 5 |
| solvent | | | | | | |

“Prep. Ex.” stands for “Preparation Example”.

### Example 1

[Production of Laminate]

The coating solution 1 formulated in Formulation Example 1 was applied to each of surfaces of polycarbonate (PC-1600, manufactured by Takiron Co., Ltd. and having a thickness of 2.0 mm), an acrylic sheet (SUMIPEX, manufactured by Sumitomo Chemical Co., Ltd. and having a thickness of 2.0 mm), flow glass (having a thickness of 2.0 mm), and an acrylic silicon base material, the polycarbonate, the acrylic sheet, the flow glass, and the acrylic silicon base material each serving as a base material, by use of a bar coater #20 so that a film dried had a thickness of approximately 6 μm.

Next, a hot air dryer was used, at 80° C. over 10 minutes, to simultaneously complete removal of the diluting solvent contained in the applied coating solution 1 and a curing reaction (hereinafter referred to as “heat curing”), so that a test piece was obtained.

Various physical properties of the obtained test piece were measured. Table 7 shows results of the measurement. In Table 7, the polycarbonate is referred to as “PC,” the acrylic sheet is referred to as “Acrylic,” the flow glass is referred to as “Glass,” and the acrylic silicon base material is referred to as “Acrylic silicon.”

Note that the acrylic silicon base material is a laminate produced by using the bar coater #20 to apply a coating solution, in which (a) acrylic silicon (a composition containing TSMA (3-methacryloyloxy propyltrimethoxysilane) in an amount of 10 parts by weight and MMA (methyl methacrylate) in an amount of 90 parts by weight, and having a number average molecular weight of 15000) and (b) methyl silicate 51 (product name) manufactured by COLCOAT CO., LTD. were blended so that a solid content weight ratio would be 80:20 and which had been regulated by use of PGME so as to have a solid content of 20% by weight, to the surface of the polycarbonate (PC-1600, manufactured by Takiron Co., Ltd. and having a thickness of 2.0 mm), so that a film dried had a thickness of approximately 6 μm.

### Example 2

Example 2 obtained a test piece by carrying out heat curing as in the case of Example 1, except that Example 2 used a coating solution 2 instead of the coating solution 1. Table 7 shows results of measurement of various physical properties of the test piece thus obtained.

### Example 3

Example 3 obtained a test piece by carrying out heat curing as in the case of Example 1, except that Example 3 used a coating solution 3 instead of the coating solution 1. Table 7 shows results of measurement of various physical properties of the test piece thus obtained.

### Example 4

Example 4 obtained a test piece by carrying out heat curing as in the case of Example 1, except that Example 4 used a coating solution 4 instead of the coating solution 1. Table 7 shows results of measurement of various physical properties of the test piece thus obtained.

### Example 5

Example 5 obtained a test piece by carrying out heat curing as in the case of Example 1, except that Example 5 used a coating solution 5 instead of the coating solution 1. Table 7 shows results of measurement of various physical properties of the test piece thus obtained.

### Example 6

Example 6 obtained a test piece by carrying out heat curing as in the case of Example 1, except that Example 6 used a coating solution 6 instead of the coating solution 1. Table 7 shows results of measurement of various physical properties of the test piece thus obtained.

### Example 7

Example 7 obtained a test piece by carrying out heat curing as in the case of Example 1, except that Example 7 used a coating solution 12 instead of the coating solution 1. Table 7 shows results of measurement of various physical properties of the test piece thus obtained.

### Example 8

Example 8 obtained a test piece by carrying out heat curing as in the case of Example 1, except that Example 8 used a coating solution 13 instead of the coating solution 1. Table 7 shows results of measurement of various physical properties of the test piece thus obtained.

### Example 9

Example 9 obtained a test piece by carrying out heat curing as in the case of Example 1, except that Example 9 used a coating solution 14 instead of the coating solution 1. Table 7 shows results of measurement of various physical properties of the test piece thus obtained.

### Example 10

Example 10 obtained a test piece by carrying out heat curing as in the case of Example 1, except that Example 10 used a coating solution 16 instead of the coating solution 1. Table 7 shows results of measurement of various physical properties of the test piece thus obtained.

### Example 11

Example 11 obtained a test piece by carrying out heat curing as in the case of Example 1, except that Example 11 used a coating solution 17 instead of the coating solution 1. Table 7 shows results of measurement of various physical properties of the test piece thus obtained.

### Example 12

Example 12 obtained a test piece by carrying out heat curing as in the case of Example 1, except that Example 12 used a coating solution 18 instead of the coating solution 1. Table 7 shows results of measurement of various physical properties of the test piece thus obtained.

### Example 13

Example 13 obtained a test piece by carrying out heat curing as in the case of Example 1, except that Example 13 used a coating solution 19 instead of the coating solution 1. Table 7 shows results of measurement of various physical properties of the test piece thus obtained.

### Example 14

Example 14 obtained a test piece by carrying out heat curing as in the case of Example 1, except that Example 14 used a coating solution 20 instead of the coating solution 1. Table 7 shows results of measurement of various physical properties of the test piece thus obtained.

### Example 15

Example 15 obtained a test piece by carrying out heat curing as in the case of Example 1, except that Example 15 used a coating solution 22 instead of the coating solution 1. Table 7 shows results of measurement of various physical properties of the test piece thus obtained.

### Example 16

Example 16 obtained a test piece by carrying out heat curing as in the case of Example 1, except that Example 16 used a coating solution 23 instead of the coating solution 1. Table 8 shows results of measurement of various physical properties of the test piece thus obtained.

### Example 17

Example 17 obtained a test piece by carrying out heat curing as in the case of Example 1, except that Example 17 used a coating solution 24 instead of the coating solution 1. Table 8 shows results of measurement of various physical properties of the test piece thus obtained.

### Example 18

Example 18 obtained a test piece by carrying out heat curing as in the case of Example 1, except that Example 18 used a coating solution 25 instead of the coating solution 1. Table 8 shows results of measurement of various physical properties of the test piece thus obtained.

### Example 19

Example 19 obtained a test piece by carrying out heat curing as in the case of Example 1, except that Example 19 used a coating solution 26 instead of the coating solution 1. Table 8 shows results of measurement of various physical properties of the test piece thus obtained.

### Example 20

Example 20 obtained a test piece by carrying out heat curing as in the case of Example 1, except that Example 20 used a coating solution 27 instead of the coating solution 1. Table 8 shows results of measurement of various physical properties of the test piece thus obtained.

### Example 21

Example 21 obtained a test piece by carrying out heat curing as in the case of Example 1, except that Example 21 used a coating solution 28 instead of the coating solution 1. Table 8 shows results of measurement of various physical properties of the test piece thus obtained.

### Example 22

Example 22 obtained a test piece by carrying out heat curing as in the case of Example 1, except that Example 22 used a coating solution 29 instead of the coating solution 1. Table 8 shows results of measurement of various physical properties of the test piece thus obtained.

### Example 23

Example 23 obtained a test piece by carrying out heat curing as in the case of Example 1, except that Example 23 used a coating solution 30 instead of the coating solution 1. Table 8 shows results of measurement of various physical properties of the test piece thus obtained.

### Example 24

Example 24 obtained a test piece by carrying out heat curing as in the case of Example 1, except that Example 24 used a coating solution 31 instead of the coating solution 1. Table 8 shows results of measurement of various physical properties of the test piece thus obtained.

### Example 25

Example 25 obtained a test piece by carrying out heat curing as in the case of Example 1, except that Example 25 used a coating solution 32 instead of the coating solution 1. Table 8 shows results of measurement of various physical properties of the test piece thus obtained.

### Example 26

Example 26 obtained a test piece by carrying out heat curing as in the case of Example 1, except that Example 26 used a coating solution 33 instead of the coating solution 1. Table 8 shows results of measurement of various physical properties of the test piece thus obtained.

### Example 27

Example 27 obtained a test piece by carrying out heat curing as in the case of Example 1, except that Example 27 used a coating solution 34 instead of the coating solution 1. Table 8 shows results of measurement of various physical properties of the test piece thus obtained.

### Example 28

Example 28 obtained a test piece by carrying out heat curing as in the case of Example 1, except that Example 28 used a coating solution 35 instead of the coating solution 1. Table 8 shows results of measurement of various physical properties of the test piece thus obtained.

### Example 29

Example 29 obtained a test piece by carrying out heat curing as in the case of Example 1, except that Example 29 used a coating solution 36 instead of the coating solution 1. Table 8 shows results of measurement of various physical properties of the test piece thus obtained.

### Example 30

Example 30 obtained a test piece by carrying out heat curing as in the case of Example 1, except that Example 30 used a coating solution 37 instead of the coating solution 1. Table 8 shows results of measurement of various physical properties of the test piece thus obtained.

### Example 31

Example 31 obtained a test piece by carrying out heat curing as in the case of Example 1, except that Example 31 used a coating solution 38 instead of the coating solution 1. Table 8 shows results of measurement of various physical properties of the test piece thus obtained.

TABLE 7

| | | | Example | | | | | | | |
|---|---|---|---|---|---|---|---|---|---|---|
| | | | Example 1 | Example 2 | Example 3 | Example 4 | Example 5 | Example 6 | Example 7 | Example 8 |
| | | | Coating solution | | | | | | | |
| | | | Coating | Coating | Coating | Coating | Coating | Coating | Coating | Coating |
| | | | solution 1 | solution 2 | solution 3 | solution 4 | solution 5 | solution 6 | solution 12 | solution 13 |
| Base | PC | Transparency | Trans- | Trans- | Trans- | Trans- | Trans- | Trans- | Trans- | Trans- |
| material | | of coated film | parent | parent | parent | parent | parent | parent | parent | parent |
| | | Initial | 100 | 100 | 100 | 100 | 100 | 100 | 100 | 100 |
| | | adhesion | | | | | | | | |
| | | (point) | | | | | | | | |
| | | Boiling water | 100 | 100 | 100 | 100 | 100 | 100 | 100 | 100 |
| | | 1 Hr adhesion | | | | | | | | |
| | | (point) | | | | | | | | |
| | | Boiling water | G | G | G | G | G | G | G | G |
| | | 1 Hr crack | | | | | | | | |
| | | Boiling water | 100 | 100 | 100 | 100 | 30 | 100 | 90 | 100 |
| | | 2 Hr adhesion | | | | | | | | |
| | | (point) | | | | | | | | |
| | | Boiling water | G | G | G | G | G | G | G | G |
| | | 2 Hr crack | | | | | | | | |
| | Acrylic | Initial | 100 | 100 | 100 | 100 | 100 | 100 | 100 | 100 |
| | | adhesion | | | | | | | | |
| | | (point) | | | | | | | | |
| | Glass | Initial | 100 | 100 | 100 | 100 | 100 | 100 | 100 | 100 |
| | | adhesion | | | | | | | | |
| | | (point) | | | | | | | | |
| | | Boiling water | 100 | 100 | 100 | 100 | 100 | 100 | 100 | 100 |
| | | 1 Hr adhesion | | | | | | | | |
| | | (point) | | | | | | | | |
| | | Alkali | G | G | G | G | G | G | G | G |
| | | resistance | | | | | | | | |
| | | Resistance to | G | G | G | G | G | G | G | G |
| | | nail scratch | | | | | | | | |
| | | 200° C. 1 Hr | G | G | G | G | G | G | G | G |
| | | crack | | | | | | | | |
| | | 200° C. → 5° C. | G | G | G | G | G | G | G | G |
| | | cooling crack | | | | | | | | |
| | | 300° C. 30 min | G | G | G | G | G | G | G | G |
| | | crack | | | | | | | | |
| | Acrylic | Initial | 100 | 100 | 100 | 100 | 100 | 100 | 100 | 100 |
| | silicon | adhesion | | | | | | | | |
| | | (point) | | | | | | | | |
| | | Boiling water | 100 | 100 | 100 | 100 | 95 | 100 | 30 | 100 |
| | | 1 Hr adhesion | | | | | | | | |
| | | (point) | | | | | | | | |

| | | | Example | | | | | | |
|---|---|---|---|---|---|---|---|---|---|
| | | | Example 9 | Example 10 | Example 11 | Example 12 | Example 13 | Example 14 | Example 15 |
| | | | Coating solution | | | | | | |
| | | | Coating | Coating | Coating | Coating | Coating | Coating | Coating |
| | | | solution 14 | solution 16 | solution 17 | solution 18 | solution 19 | solution 20 | solution 22 |
| Base | PC | Transparency | Trans- | Trans- | Trans- | Trans- | Trans- | Trans- | Trans- |
| material | | of coated film | parent | parent | parent | parent | parent | parent | parent |
| | | Initial | 100 | 100 | 100 | 100 | 100 | 100 | 100 |
| | | adhesion | | | | | | | |
| | | (point) | | | | | | | |
| | | Boiling water | 100 | 100 | 100 | 100 | 50 | 0 | 100 |
| | | 1 Hr adhesion | | | | | | | |
| | | (point) | | | | | | | |
| | | Boiling water | G | G | G | G | G | G | G |
| | | 1 Hr crack | | | | | | | |
| | | Boiling water | 100 | 100 | 100 | 100 | 0 | 0 | 100 |
| | | 2 Hr adhesion | | | | | | | |
| | | (point) | | | | | | | |
| | | Boiling water | G | G | G | G | F | F | G |
| | | 2 Hr crack | | | | | | | |
| | Acrylic | Initial | 100 | 100 | 100 | 100 | 100 | 100 | 100 |
| | | adhesion | | | | | | | |
| | | (point) | | | | | | | |
| | Glass | Initial | 100 | 100 | 100 | 100 | 100 | 100 | 100 |
| | | adhesion | | | | | | | |
| | | (point) | | | | | | | |
| | | Boiling water | 100 | 100 | 100 | 100 | 100 | 100 | 100 |
| | | 1 Hr adhesion | | | | | | | |
| | | (point) | | | | | | | |
| | | Alkali | G | G | G | G | G | G | G |
| | | resistance | | | | | | | |
| | | Resistance to | G | G | G | G | G | G | G |
| | | nail scratch | | | | | | | |
| | | 200° C. 1 Hr | G | G | G | G | G | G | G |
| | | crack | | | | | | | |
| | | 200° C. → 5° C. | G | G | G | G | P | P | G |
| | | cooling crack | | | | | | | |
| | | 300° C. 30 min | G | P | P | G | G | G | G |
| | | crack | | | | | | | |
| | Acrylic | Initial | 100 | 100 | 100 | 100 | 100 | 100 | 100 |
| | silicon | adhesion | | | | | | | |
| | | (point) | | | | | | | |
| | | Boiling water | 100 | 80 | 95 | 100 | 100 | 100 | 100 |
| | | 1 Hr adhesion | | | | | | | |
| | | (point) | | | | | | | |

“G” stands for “Good”.
“F” stands for “Fair”.
“P” stands for “Poor”.

TABLE 8

Example

| | | | | | | | |
|---|---|---|---|---|---|---|---|
| Exam- | Exam- | Exam- | Exam- | Exam- | Exam- | Exam- | Exam- |
| ple 16 | ple 17 | ple 18 | ple 19 | ple 20 | ple 21 | ple 22 | ple 23 |

Coating solution

| | | | Coating | Coating | Coating | Coating | Coating | Coating | Coating | Coating |
|---|---|---|---|---|---|---|---|---|---|---|
| | | | solu- | solu- | solu- | solu- | solu- | solu- | solu- | solu- |
| | | | tion 23 | tion 24 | tion 25 | tion 26 | tion 27 | tion 28 | tion 29 | tion 30 |
| Base | PC | Transparency | Trans- | Trans- | Trans- | Trans- | Trans- | Trans- | Trans- | Trans- |
| material | | of coated film | parent | parent | parent | parent | parent | parent | parent | parent |
| | | Initial | 100 | 100 | 100 | 100 | 100 | 100 | 100 | 100 |
| | | adhesion | | | | | | | | |
| | | (point) | | | | | | | | |
| | | Boiling water | 100 | 100 | 100 | 100 | 100 | 100 | 100 | 100 |
| | | 1 Hr adhesion | | | | | | | | |
| | | (point) | | | | | | | | |
| | | Boiling water | G | G | G | G | G | G | G | G |
| | | 1 Hr crack | | | | | | | | |
| | | Boiling wafer | 80 | 30 | 100 | 100 | 100 | 60 | 100 | 100 |
| | | 2 Hr adhesion | | | | | | | | |
| | | (point) | | | | | | | | |
| | | Boiling water | G | G | G | G | G | G | G | G |
| | | 2 Hr crack | | | | | | | | |
| | Acrylic | Initial | 100 | 0 | 100 | 100 | 100 | 100 | 100 | 100 |
| | | adhesion | | | | | | | | |
| | | (point) | | | | | | | | |
| | Glass | Initial | 100 | 100 | 100 | 100 | 100 | 100 | 100 | 100 |
| | | adhesion | | | | | | | | |
| | | (point) | | | | | | | | |
| | | Boiling water | 100 | 100 | 100 | 100 | 100 | 100 | 100 | 100 |
| | | 1 Hr adhesion | | | | | | | | |
| | | (point) | | | | | | | | |
| | | Alkali | P | G | G | G | G | G | G | G |
| | | resistance | | | | | | | | |
| | | Resistance to | G | P | G | G | G | G | G | G |
| | | nail scratch | | | | | | | | |
| | | 200° C. 1 Hr | G | G | G | G | G | G | G | G |
| | | crack | | | | | | | | |
| | | 200° C. → 5° C. | G | G | G | G | G | G | G | G |
| | | cooling crack | | | | | | | | |
| | | 300° C. 30 min | G | G | G | G | G | G | G | G |
| | | crack | | | | | | | | |
| | Acrylic | Initial | 100 | 100 | 100 | 100 | 100 | 100 | 100 | 100 |
| | silicon | adhesion | | | | | | | | |
| | | (point) | | | | | | | | |
| | | Boiling water | 90 | 20 | 100 | 100 | 100 | 100 | 100 | 100 |
| | | 1 Hr adhesion | | | | | | | | |
| | | (point) | | | | | | | | |

| | | | Example | | | | | | | |
|---|---|---|---|---|---|---|---|---|---|---|
| | | | Exam- | Exam- | Exam- | Exam- | Exam- | Exam- | Exam- | Exam- |
| | | | ple 24 | ple 25 | ple 26 | ple 27 | ple 28 | ple 29 | ple 30 | ple 31 |
| | | | Coating solution | | | | | | | |
| | | | Coating | Coating | Coating | Coating | Coating | Coating | Coating | Coating |
| | | | solu- | solu- | solu- | solu- | solu- | solu- | solu- | solu- |
| | | | tion 31 | tion 32 | tion 33 | tion 34 | tion 35 | tion 36 | tion 37 | tion 38 |
| Base | PC | Transparency | Trans- | Turbid in | Trans- | Trans- | Trans- | Trans- | Trans- | Trans- |
| material | | of coated film | parent | white | parent | parent | parent | parent | parent | parent |
| | | Initial | 100 | 100 | 100 | 100 | 100 | 100 | 100 | 100 |
| | | adhesion | | | | | | | | |
| | | (point) | | | | | | | | |
| | | Boiling water | 100 | 100 | 100 | 100 | 100 | 100 | 100 | 100 |
| | | 1 Hr adhesion | | | | | | | | |
| | | (point) | | | | | | | | |
| | | Boiling water | G | G | G | G | G | G | G | G |
| | | 1 Hr crack | | | | | | | | |
| | | Boiling water | 100 | 100 | 100 | 70 | 0 | 100 | 100 | 100 |
| | | 2 Hr adhesion | | | | | | | | |
| | | (point) | | | | | | | | |
| | | Boiling water | G | G | G | G | G | G | G | G |
| | | 2 Hr crack | | | | | | | | |
| | Acrylic | Initial | 100 | 100 | 100 | 100 | 100 | 100 | 100 | 100 |
| | | adhesion | | | | | | | | |
| | | (point) | | | | | | | | |
| | Glass | Initial | 100 | 100 | 100 | 100 | 100 | 100 | 100 | 100 |
| | | adhesion | | | | | | | | |
| | | (point) | | | | | | | | |
| | | Boiling water | 100 | 100 | 100 | 100 | 100 | 100 | 100 | 100 |
| | | 1 Hr adhesion | | | | | | | | |
| | | (point) | | | | | | | | |
| | | Alkali | G | G | G | G | G | G | G | G |
| | | resistance | | | | | | | | |
| | | Resistance to | G | G | G | G | G | G | G | G |
| | | nail scratch | | | | | | | | |
| | | 200° C. 1 Hr | G | G | G | G | G | G | G | G |
| | | crack | | | | | | | | |
| | | 200° C. → 5° C. | G | G | G | G | G | G | G | G |
| | | cooling crack | | | | | | | | |
| | | 300° C. 30 min | G | G | G | G | G | G | G | G |
| | | crack | | | | | | | | |
| | Acrylic | Initial | 100 | 100 | 100 | 100 | 100 | 100 | 100 | 100 |
| | silicon | adhesion | | | | | | | | |
| | | (point) | | | | | | | | |
| | | Boiling water | 100 | 80 | 90 | 100 | 70 | 100 | 100 | 100 |
| | | 1 Hr adhesion | | | | | | | | |
| | | (point) | | | | | | | | |

“G” stands for “Good”.
“P” stands for “Poor”.

### Comparative Example 1

Comparative Example 1 obtained a test piece by carrying out heat curing as in the case of Example 1, except that Comparative Example 1 used a coating solution 7 instead of the coating solution 1. Table 9 shows results of measurement of various physical properties of the test piece thus obtained.

### Comparative Example 2

Comparative Example 2 obtained a test piece by carrying out heat curing as in the case of Example 1, except that Comparative Example 2 used a coating solution 8 instead of the coating solution 1. Table 9 shows results of measurement of various physical properties of the test piece thus obtained.

### Comparative Example 3

Comparative Example 3 obtained a test piece by carrying out heat curing as in the case of Example 1, except that Comparative Example 3 used a coating solution 9 instead of the coating solution 1. Table 9 shows results of measurement of various physical properties of the test piece thus obtained.

### Comparative Example 4

Comparative Example 4 obtained a test piece by carrying out heat curing as in the case of Example 1, except that Comparative Example 4 used a coating solution 10 instead of the coating solution 1. Table 9 shows results of measurement of various physical properties of the test piece thus obtained.

### Comparative Example 5

Comparative Example 5 obtained a test piece by carrying out heat curing as in the case of Example 1, except that Comparative Example 5 used a coating solution 11 instead of the coating solution 1. Table 9 shows results of measurement of various physical properties of the test piece thus obtained.

### Comparative Example 6

As shown in Preparation Example 14 of Table 3, a blended product obtained by use of the solution of organopolysiloxane which solution had been obtained in Production Example 1 and the solution of acrylic silicon which solution had been obtained in Synthesis Example 2 was stirred at 80° C. for 6 hours so as to prepare the composite resin (A) having a solid content of 60% by weight, and, as a result, a reaction solution thickened and gelated.

### Comparative Example 7

As shown in Preparation Example 16 of Table 3, a blended product obtained by use of the solution of organopolysiloxane which solution had been obtained in Production Example 3 and the solution of acrylic silicon which solution had been obtained in Synthesis Example 12 was stirred at 80° C. for 6 hours so as to prepare the composite resin (A) having a solid content of 40% by weight, and, as a result, a reaction solution thickened and gelated.

### Comparative Example 8

As shown in Preparation Example 17 of Table 3, a blended product obtained by use of the solution of organopolysiloxane which solution had been obtained in Production Example 4 and the solution of acrylic silicon which solution had been obtained in Synthesis Example 13 was stirred at 80° C. for 6 hours so as to prepare the composite resin (A) having a solid content of 40% by weight, and, as a result, a reaction solution thickened and gelated.

### Comparative Example 9

Comparative Example 9 obtained a test piece by carrying out heat curing as in the case of Example 1, except that Comparative Example 9 used a coating solution 15 instead of the coating solution 1. Table 9 shows results of measurement of various physical properties of the test piece thus obtained.

### Comparative Example 10

Comparative Example 10 obtained a test piece by carrying out heat curing as in the case of Example 1, except that Comparative Example 10 used a coating solution 21 instead of the coating solution 1. Table 9 shows results of measurement of various physical properties of the test piece thus obtained.

TABLE 9

| | | | Example | | | | |
|---|---|---|---|---|---|---|---|
| | | | Comparative | Comparative | Comparative | Comparative | Comparative |
| | | | Example 1 | Example 2 | Example 3 | Example 4 | Example 5 |
| | | | Coating solution | | | | |
| | | | Coating | Coating | Coating | Coating | Coating |
| | | | solution 7 | solution 8 | solution 9 | solution 10 | solution 11 |
| Base | PC | Transparency | Transparent | Transparent | Transparent | Transparent | Transparent |
| material | | of coated film | | | | | |
| | | Initial | 100 | 100 | 100 | 100 | 100 |
| | | adhesion | | | | | |
| | | (point) | | | | | |
| | | Boiling water | 100 | 100 | 100 | 100 | 100 |
| | | 1 Hr adhesion | | | | | |
| | | (point) | | | | | |
| | | Boiling water | G | G | G | G | G |
| | | 1 Hr crack | | | | | |
| | | Boiling water | 100 | 100 | 100 | 100 | 100 |
| | | 2 Hr adhesion | | | | | |
| | | (point) | | | | | |
| | | Boiling water | G | G | G | G | G |
| | | 2 Hr crack | | | | | |
| | Acrylic | Initial | 100 | 100 | 100 | 100 | 100 |
| | | adhesion | | | | | |
| | | (point) | | | | | |
| | Glass | Initial | 100 | 100 | 100 | 100 | 100 |
| | | adhesion | | | | | |
| | | (point) | | | | | |
| | | Boiling water | 100 | 100 | 100 | 100 | 100 |
| | | 1 Hr adhesion | | | | | |
| | | (point) | | | | | |
| | | Alkali | G | G | G | G | P |
| | | resistance | | | | | |
| | | Resistance to | G | G | G | G | G |
| | | nail scratch | | | | | |
| | | 200° C. 1 Hr | G | G | G | G | G |
| | | crack | | | | | |
| | | 200° C. → 5° C. | G | G | G | G | G |
| | | cooling crack | | | | | |
| | | 300° C. 30 min | G | G | G | G | G |
| | | crack | | | | | |
| | Acrylic | Initial | 100 | 100 | 100 | 100 | 100 |
| | silicon | adhesion | | | | | |
| | | (point) | | | | | |
| | | Boiling water | 100 | 100 | 100 | 100 | 0 |
| | | 1 Hr adhesion | | | | | |
| | | (point) | | | | | |
| | | | Example | | | | |
| | | | Comparative | Comparative | Comparative | Comparative | Comparative |
| | | | Example 6 | Example 7 | Example 8 | Example 9 | Example 10 |
| | | | Coating solution | | | | |
| | | | | | | Coating | Coating |
| | | | — | — | — | solution 15 | solution 21 |
| Base | PC | Transparency | — | — | — | Transparent | Transparent |
| material | | of coated film | | | | | |
| | | Initial | — | — | — | 100 | 0 |
| | | adhesion | | | | | |
| | | (point) | | | | | |
| | | Boiling water | — | — | — | 100 | 0 |
| | | 1 Hr adhesion | | | | | |
| | | (point) | | | | | |
| | | Boiling water | — | — | — | G | G |
| | | 1 Hr crack | | | | | |
| | | Boiling water | — | — | — | 100 | 0 |
| | | 2 Hr adhesion | | | | | |
| | | (point) | | | | | |
| | | Boiling water | — | — | — | G | P |
| | | 2 Hr crack | | | | | |
| | Acrylic | Initial | — | — | — | 100 | 0 |
| | | adhesion | | | | | |
| | | (point) | | | | | |
| | Glass | Initial | — | — | — | 100 | 100 |
| | | adhesion | | | | | |
| | | (point) | | | | | |
| | | Boiling water | — | — | — | 100 | 100 |
| | | 1 Hr adhesion | | | | | |
| | | (point) | | | | | |
| | | Alkali | — | — | — | P | G |
| | | resistance | | | | | |
| | | Resistance to | — | — | — | G | G |
| | | nail scratch | | | | | |
| | | 200° C. 1 Hr | — | — | — | P | G |
| | | crack | | | | | |
| | | 200° C. → 5° C. | — | — | — | — | P |
| | | cooling crack | | | | | |
| | | 300° C. 30 min | — | — | — | P | G |
| | | crack | | | | | |
| | Acrylic | Initial | — | — | — | 100 | 100 |
| | silicon | adhesion | | | | | |
| | | (point) | | | | | |
| | | Boiling water | — | — | — | 0 | 100 |
| | | 1 Hr adhesion | | | | | |
| | | (point) | | | | | |

“G” stands for “Good”.
“P” stands for “Poor”.

In each of Comparative Examples 1 to 4, a coated film having favorable physical properties was obtained, but the composite resin (A) which had been synthesized and then was left standing at 23° C. gelated over time due to a great number average molecular weight of the acrylic silicon (a2) which had been used for the compositing reaction. In Comparative Example 5, a coated film having low water resistance was obtained because the compositing reaction unsatisfactorily progressed due to a low solid content concentration during synthesis of the composite resin (A). In Comparative Example 6, the composite resin (A) which was being synthesized gelated due to a too high solid content concentration during synthesis of the composite resin (A). In each of Comparative Examples 7 and 8, since a water-insoluble solvent was used as the diluting solvent to synthesize the composite resin (A), the reaction progressed in a heterogeneous system in which the organopolysiloxane (a1) and the composite resin (A) were undissolved, so that the composite resin (A) locally had a high-concentration solid content and gelated. In Comparative Example 9, the composite resin (A) in which the organopolysiloxane (a1) was composited in a proportion of 30% by weight was obtained, but a too low proportion of the organopolysiloxane made it impossible to obtain a coated film having high heat resistance. In Comparative Example 10, the resin in which no acrylic silicon (a2) was composited and the organopolysiloxane (a1) was singly contained was obtained and had extremely high heat resistance due to the densest siloxane cross-links formed in the resin, but a crack was more likely to appear in the resin due to considerable cure shrinkage of the resin, and a coated film was less adhesive to a base material.

In Example 5, a monomer unit containing a hydrolyzable silyl group accounts for a slightly high proportion of 12% by weight of monomer units constituting the acrylic silicon (a2). In Example 27, a monomer unit containing a hydrolyzable silyl group accounts for a slightly high proportion of 10% by weight of monomer units constituting the acrylic silicon (a2). Thus, in each of Examples 5 and 27, a deterioration in adhesion of a coated film to a base material was observed in a boiling water test (“Boiling water 1 Hr adhesion” and “Boiling water 2 Hr adhesion”) depending on a substrate selected. Example 7 has a higher compositing concentration of 30% by weight during synthesis of the composite resin (A) than Comparative Example 5, and is excellent but still unsatisfactory in performance of the composite resin (A). In Example 7, the compositing reaction unsatisfactorily progressed, and a deterioration in adhesion of a coated film to a base material was observed in a boiling water test (“Boiling water 1 Hr adhesion” and “Boiling water 2 Hr adhesion”) depending on a substrate selected. Examples 10 and 11 obtained the composite resin (A) in which the organopolysiloxane (a1) was composited in a proportion of 40% by weight and the composite resin (A) in which the organopolysiloxane (a1) was composited in a proportion of 50% by weight, respectively. Each of Examples 10 and 11 is higher than Comparative Example 9 in proportion in which the organopolysiloxane (a1) was composited in the composite resin (A), and is excellent but still unsatisfactory in performance of the composite resin (A). Thus, a crack appeared in a cured coated film of the composite resin (A) in a 300° C. heat resistance test (“300° C. 30 min crack”) depending on a substrate selected. Examples 13 and 14 obtained the composite resin (A) in which the organopolysiloxane (a1) was composited in a too high proportion of 80% by weight and the composite resin (A) in which the organopolysiloxane (a1) was composited in a too high proportion of 90% by weight, respectively. Thus, in each of Examples 13 and 14, the composite resin (A) has extremely high heat resistance, but considerable cure shrinkage occurred in the composite resin (A). This resulted in insufficient secondary adhesion of a coated film to a base material (“Boiling water 1 Hr adhesion” and “Boiling water 2 Hr adhesion”) depending on a substrate selected. Note, however, that adhesion of a coated film to a base material to which a coating solution containing the acrylic silicon (a2) was applied is excellent also after immersion of a laminate in boiling water. In a case where an object to which the coated film to adhere (base material) is properly selected, it is possible to obtain an excellent laminate. In Examples 16 and 17, organic groups of organotrialkoxysilane are an ethyl group and a hexyl group, respectively, each of which is bulkier than a methyl group. Thus, in each of Examples 16 and 17, a crosslinking reaction unsatisfactorily progressed during formation of a coated film, and a coated film having insufficient adhesion after immersion of a laminate in boiling water was obtained depending on a substrate selected. In Example 21, a methacrylate ester unit accounts for not more than 65% by weight of monomer units constituting the acrylic silicon (a2), and the composite resin (A) was at a level that practically has no problem, but a coated film had poorer adhesion after immersion of a laminate in boiling water depending on a substrate selected. In Example 25, a monomer unit containing a hydrolyzable silyl group accounts for a low proportion of 2% by weight of monomer units constituting the acrylic silicon (a2), a coated film was turbid in white, and observation on adhesion of a coated film, after immersion of a laminate in boiling water, to a base material to which the acrylic silicon (a2) was applied reveals that the coated film was partially peeled from the base material. Note, however, that such inconveniences as described above can be mitigated by more thinly applying coating to a coated film and/or using, during formation of a coated film, a catalyst for promoting reaction of a hydrolyzable silyl group. In Example 28, water was used for synthesis of the organopolysiloxane (a1) in a small amount of 0.6 moles with respect to 1 mole of an alkoxysilyl group, and organopolysiloxane containing an alkoxysilyl group and a silanol group in a large amount was obtained. Thus, the composite resin (A) was at a level that practically has no problem, but a deterioration in adhesion after immersion of a laminate in boiling water was observed depending on a substrate selected.

In each of the other Examples, it was possible to produce a polysiloxane segment-containing composite resin which simultaneously has high heat resistance, temperature cycle resistance, and adhesion to a base material and which has high storage stability.

A method for producing a composite resin in accordance with one or more embodiments of the present invention makes it possible to produce a polysiloxane segment-containing composite resin which simultaneously has high heat resistance, temperature cycle resistance, and adhesion to a base material and which has high storage stability.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A method for producing a composite resin, comprising:
preparing an organopolysiloxane by performing a hydrolyzing and condensing process on an organotrialkoxysilane comprising alkoxysilyl groups and a hydrocarbon group; and
obtaining the composite resin by reacting the organopolysiloxane with an acrylic silicon in a reaction solution, the reaction solution comprising:
the organopolysiloxane;
the acrylic silicon;
a water-soluble organic solvent; and
an acid catalyst,
wherein the reaction solution has a solid content ranging from 30 to 55% by weight,
wherein the water-soluble organic solvent has 4 or more carbon atoms,
wherein the composite resin contains the organopolysiloxane in an amount of 40 to 90% by weight and the acrylic silicon in an amount of 10 to 60% by weight, and
wherein the acrylic silicon has a number average molecular weight of 1000 to 9000.

2. The method according to claim 1, wherein the acrylic silicon comprises a monomer unit in an amount of 3 to 11% by weight, relative to the total weight of monomer units that constitute the acrylic silicon,
wherein the monomer unit contains a hydrolyzable silyl group.

3. The method according to claim 1, wherein the organotrialkoxysilane is methyltrimethoxysilane.

4. The method according to claim 1, wherein the acrylic silicon comprises a vinyl monomer, and
wherein the vinyl monomer contains one or more silane monomers selected from the group consisting of 3-(meth)acryloyloxy propyltrimethoxysilane, 3-methacryloyloxy propylmethyl dimethoxysilane, and 3-methacryloyloxy propyltriethoxysilane.

5. The method according to claim 1, wherein the acrylic silicon comprises a vinyl monomer in an amount of not less than 65% by weight, relative to the total weight of the acrylic silicon, and
wherein the vinyl monomer contains a methacrylate ester.

6. The method according to claim 1, wherein the acrylic silicon comprises a vinyl monomer in an amount of not less than 50% by weight, relative to the total weight of the acrylic silicon, and
wherein the vinyl monomer contains a methyl methacrylate.

7. The method according to claim 1, wherein the hydrolyzing and condensing process comprises adding water in an amount of 0.6 to 4.0 moles with respect to 1 mole of the alkoxysilyl groups.

8. The method according to claim 1, further comprising curing the composite resin.

9. The method according to claim 8, further comprising:
applying the composite resin to a base material prior to curing the composite resin; and
forming a cured film by curing the composite resin.

10. The method according to claim 9, further comprising
applying a coating solution to the base material prior to applying the composite resin to the base material, wherein the coating solution contains the acrylic silicon.

11. The method according to claim 10, wherein the coating solution further contains alkylsilicate.
